(19) United States
(12) Patent Application Publication
(10) Pub. No.: US 2026/0210430 A1
(43) Pub. Date: Jul. 23, 2026

(54) MECHANICAL DEMULTIPLEXER

(71) Applicants: Mathieu TANGUAY, Longueuil (CA); GROWCLEAN TECHNOLOGIE CORP., Longueuil (CA)

(72) Inventor: Mathieu TANGUAY, Longueuil (CA)

(21) Appl. No.: 19/141,214

(22) PCT Filed: Dec. 20, 2023
(86) PCT No.: PCT/CA2023/051719

§ 371 Date: Jun. 19, 2025

Related U.S. Application Data
(60) Provisional application No. 63/433,991, filed on Dec. 20, 2022.

(51) Int. Cl. F16H 25/24; F16H 25/20

(52) U.S. Cl. CPC F16H 25/2454; F16H 25/2025; F16H 25/2006; F16H 2025/204; F16H 2025/2053; F16H 2025/2075

(57) ABSTRACT

A mechanical demultiplexer comprising a demultiplexing drive shaft assembly extending along a drive axis driven by the power source; a plurality of output modules coupled to a frame along the demultiplexing drive shaft, with the demultiplexing drive shaft being engageable to the output modules through a transmission nut thereof, wherein the mechanical demultiplexer is adapted to engage selectively and individually a number of the output modules to the demultiplexing drive shaft resulting in the demultiplexing drive shaft powering the number of engaged output modules. The demultiplexing drive shaft assembly comprises, in addition to the transmission nut: a powering element to transmit rotation to the transmission nut around the drive axis; a leading element to make the transmission nut travel along the drive axis; and a guiding element to perform linear translation of the transmission nut relative to the drive axis without rotation, preferably all powered by said power source.

### CROSS-REFERENCE TO RELATED APPLICATION(S)

The present application is a United States National Stage of International Application No. PCT/CA2023/051719 filed on Dec. 20, 2023, which claims priority on U.S. Patent Application No. 63/433,991 filed Dec. 20, 2022, the entire contents of which are incorporated herein by reference.

### FIELD OF THE INVENTION

The subject matter disclosed generally relates to mechanical gears and to automation and mechatronics. More specifically, it relates to the field of automation, mechatronics and connected industrial equipment. More specifically, it relates to a mechanical demultiplexer for torque, rotational speed, and angular position transmission.

### PRIOR ART

There are various mechanical transmission systems used across various industries for various purposes. Often, such mechanical transmission systems are dedicated to a particular use or purpose. Also, they are often rather heavy and bulky. For example, if a machine has several mechanical outputs, like a system comprising a plurality of dosing pumps and motorized valves, a motor with its controller and drive would typically be needed for each of the outputs that needs to be independently controlled, making the system more complex and costly.

Systems having independent outputs are typically limited, for example they are designed to distribute a single mechanical drive into three distinct outputs, but such systems are typically not extensible into an arbitrary number of outputs, at least not easily.

There is therefore a need for a greater granularity of control between mechanical outputs, while having a modular system which can distribute a mechanical output over an arbitrary number of outputs.

### SUMMARY

In some aspects, the description herein relates to a demultiplexing drive shaft assembly extending along a drive axis driven by a power source, including: a transmission nut; a powering element to transmit rotation to the transmission nut around the drive axis; a leading element to make the transmission nut travel along the drive axis; and a guiding element to perform linear translation of the transmission nut relative to the drive axis without rotation, wherein both the powering element and the leading element are both powered by said power source driving the drive axis.

In some aspects, the description herein relates to a demultiplexing drive shaft assembly, the powering element and the leading element are a same, single powering-and-leading structure.

In some aspects, the description herein relates to a demultiplexing drive shaft assembly, further including a guiding structure, including the guiding element, the guiding structure being different and distinct from the powering-and-leading structure.

In some aspects, the description herein relates to a demultiplexing drive shaft assembly, wherein the powering-and-leading structure is a central leadscrew including a spline.

In some aspects, the description herein relates to a demultiplexing drive shaft assembly, the powering element and the guiding element are a same, single powering-and-guiding structure.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

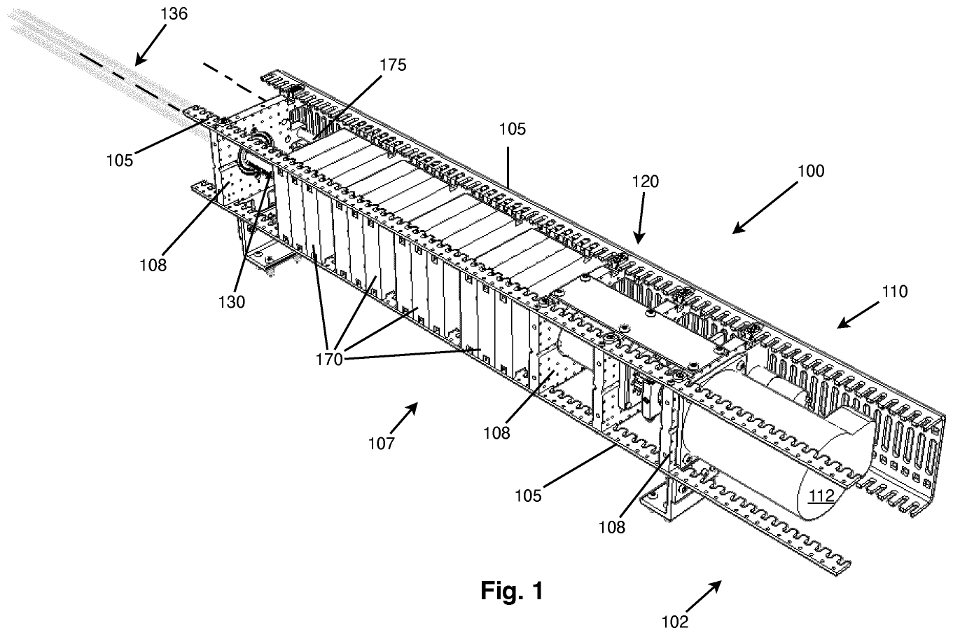

FIG. 1 is an isometric oblique view of a mechanical drive shaft from the motor side in accordance with an embodiment;

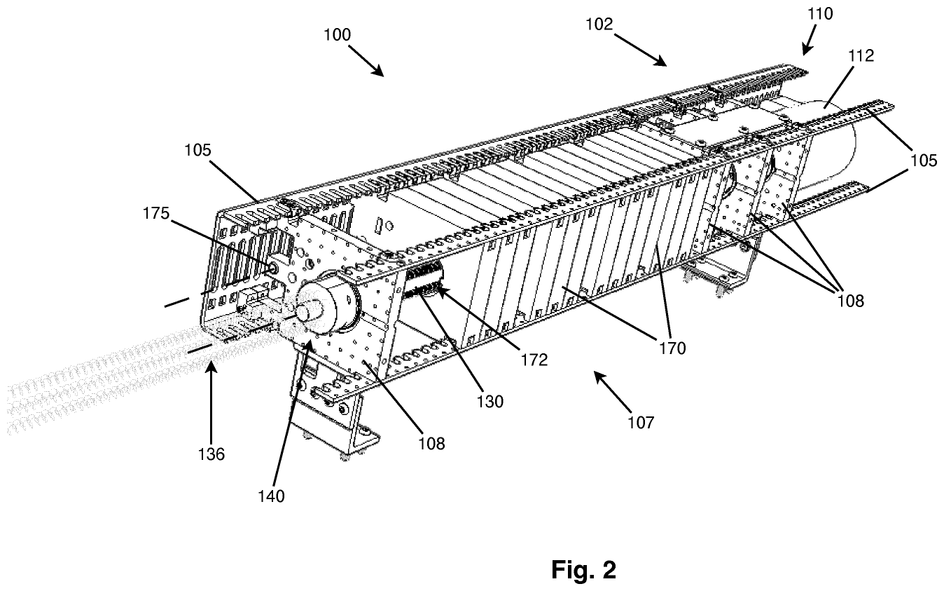

FIG. 2 is an isometric oblique view of a mechanical drive shaft from a second side in accordance with an embodiment;

FIG. 3 is an isometric oblique side view of a mechanical drive shaft from the motor side with modules hidden in accordance with an embodiment;

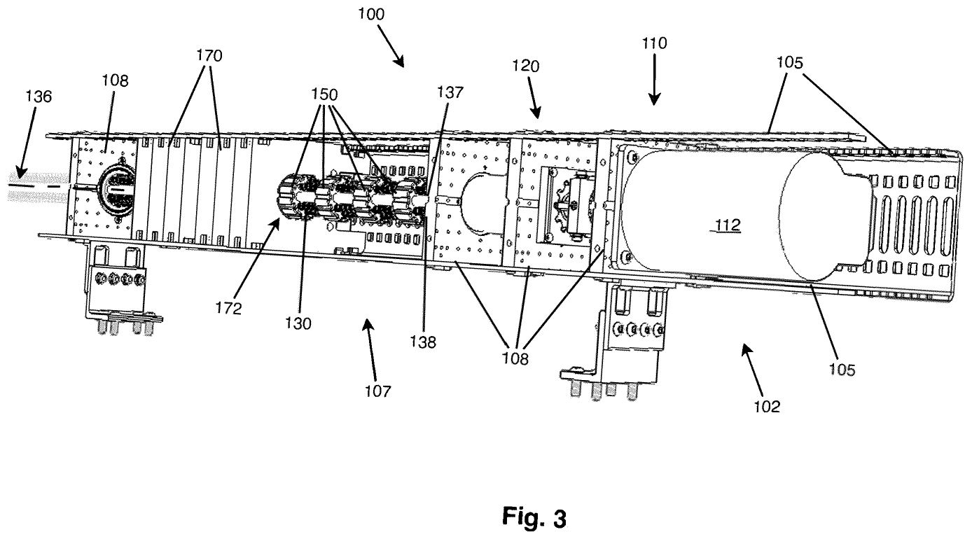

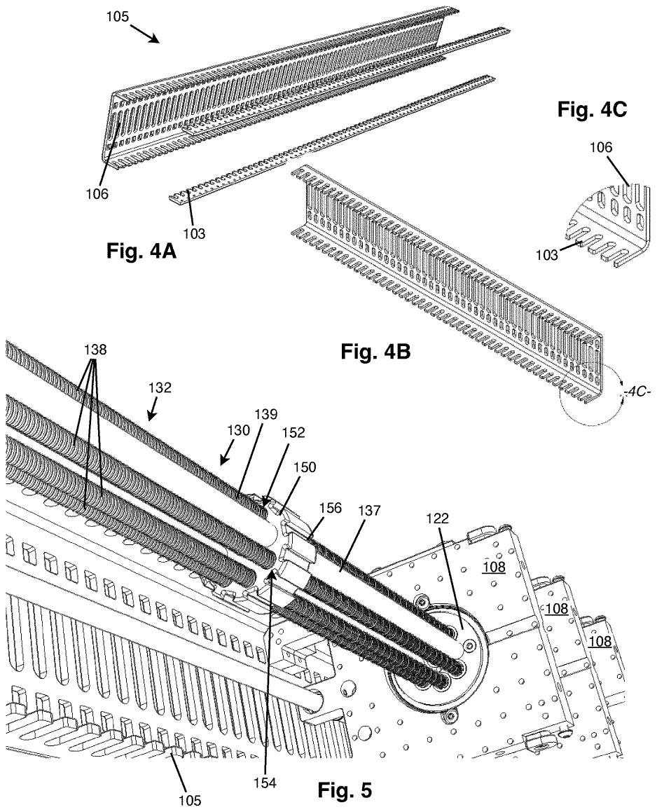

FIG. 4A is an isometric oblique view of a frame in accordance with an embodiment;

FIG. 4B is a perspective view of a piece of the frame;

FIG. 4C is a close-up view of a portion of the frame as identified on FIG. 4B;

FIG. 5 is perspective view of a powered section of a mechanical drive shaft with no output module mounted thereto and a single transmission nut one mounted thereto in accordance with an embodiment;

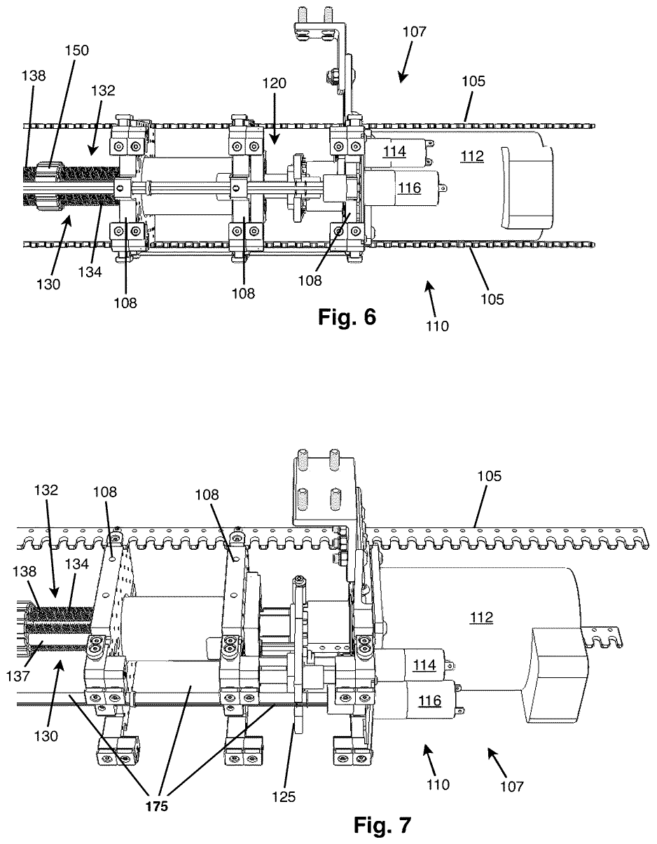

FIG. 6 is a view of a motorization portion of a mechanical drive shaft in accordance with an embodiment;

FIG. 7 is an oblique view of the motorization portion of a mechanical drive shaft in accordance with an embodiment;

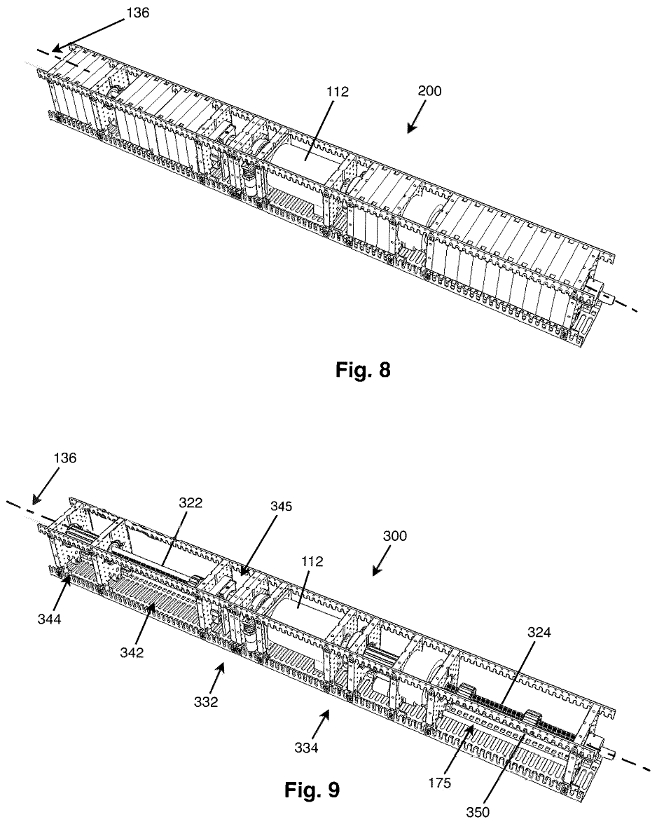

FIG. 8 is an isometric view of a mechanical demultiplexer extending in two directions in accordance with an embodiment;

FIG. 9 is an isometric view of a mechanical demultiplexer having a drive shaft extending in two directions, with transmission nuts mounted thereto, and output modules hidden in accordance with an embodiment;

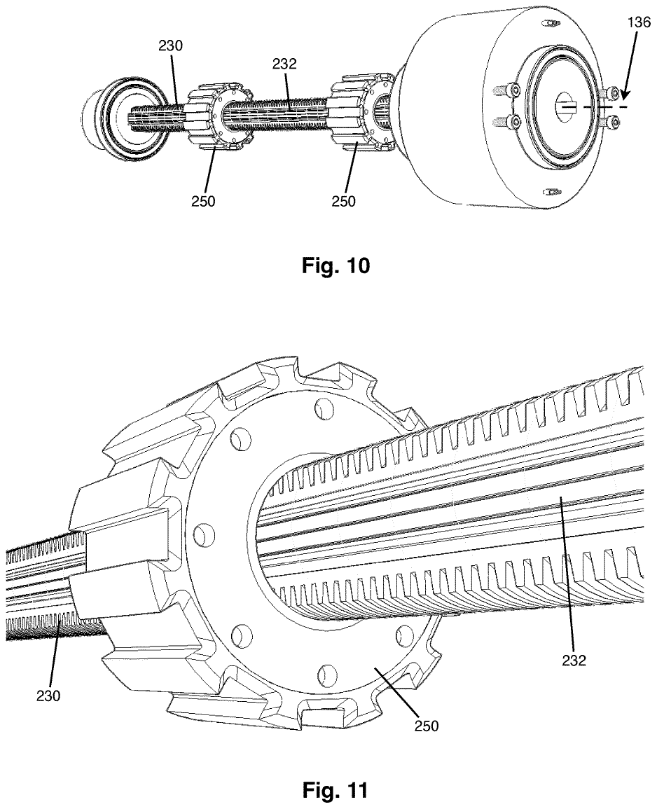

FIG. 10 is an isometric view of a drive shaft assembly electrically powered viewed from the motor end in accordance with an embodiment;

FIG. 11 is a closeup isometric view of a drive shaft comprising busbars in accordance with an embodiment;

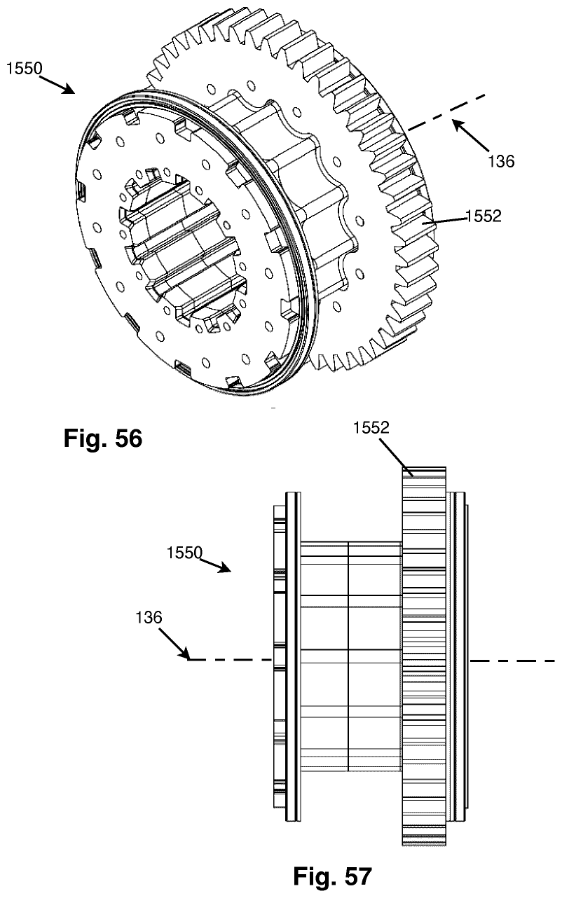

FIG. 56 is a perspective view of a rotor of an output module in accordance with an embodiment;

FIG. 57 is a side view of the rotor of FIG. 56;

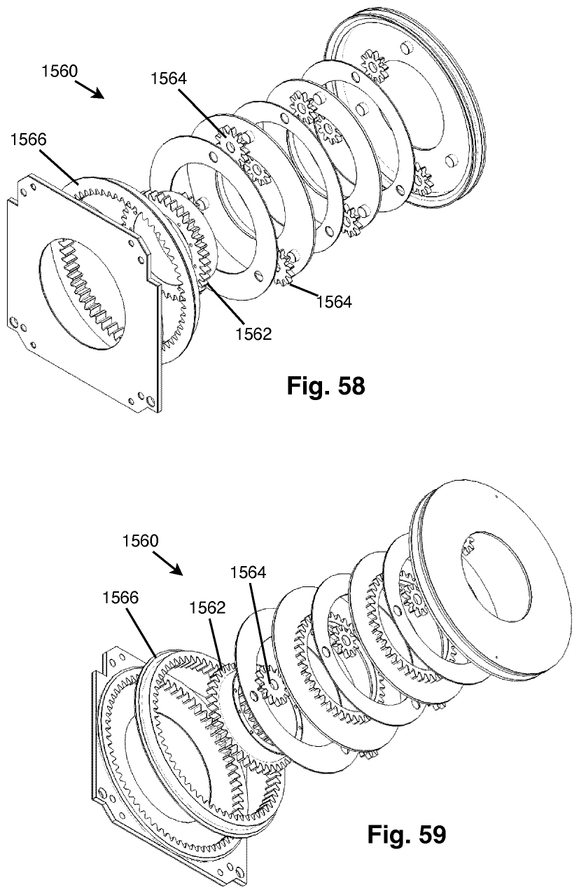

FIG. 58 and FIG. 59 are perspective exploded views a planetary gearset coupled or part of a rotor of an output module in accordance with an embodiment;

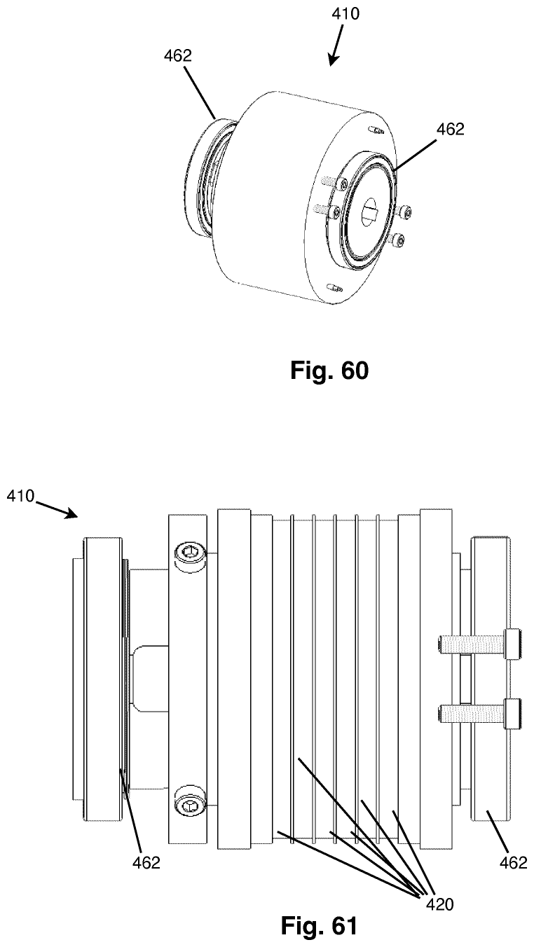

FIG. 60 is an isometric view of a slip ring of a drive shaft assembly in accordance with an embodiment;

FIG. 61 is a side view of a slip ring of a drive shaft assembly with its cap removed in accordance with an embodiment;

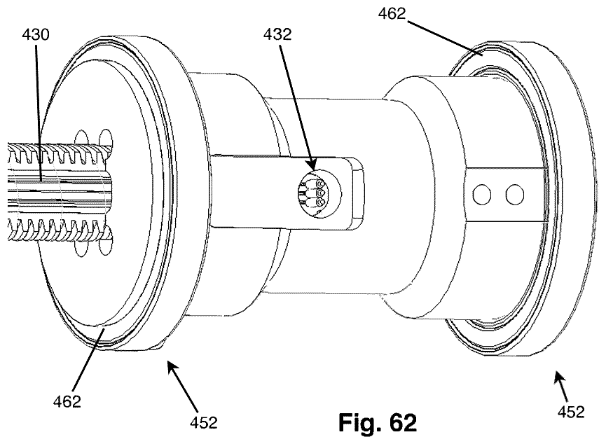

FIG. 62 is an oblique isometric view of a drive shaft assembly with the slip ring removed in accordance with an embodiment;

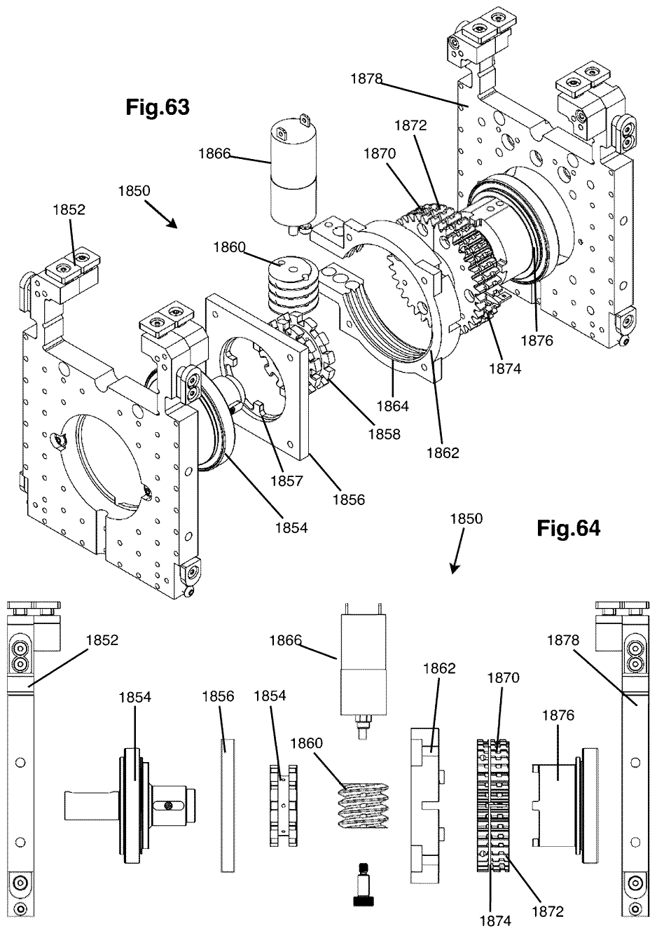

FIG. 63 is an exploded perspective view of a clutch in accordance with an embodiment ;

FIG. 64 is an exploded side view of the clutch of FIG. 63;

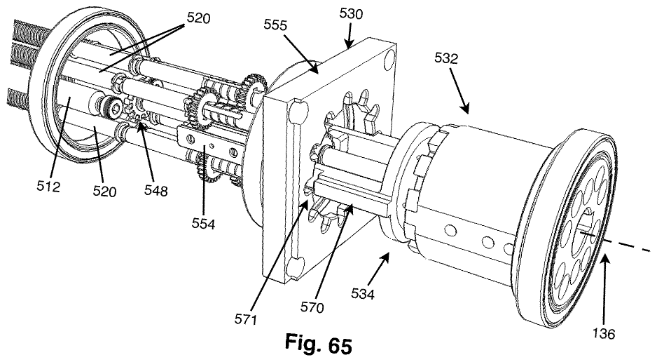

FIG. 65 is an isometric view of the portion of a drive shaft assembly in accordance with an embodiment with cover of the clutch removed;

FIG. 66 is a side view of a portion of the drive shaft assembly of FIG. 65 with cover of the cutch removed;

FIG. 67 is a side view of a close-up portion of the drive shaft assembly of FIG. 65 with cover of the cutch removed;

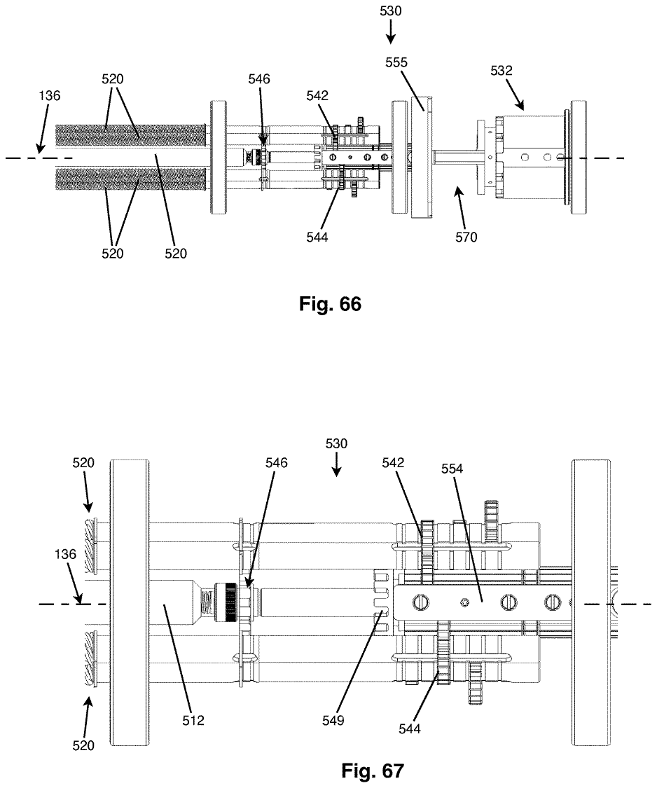

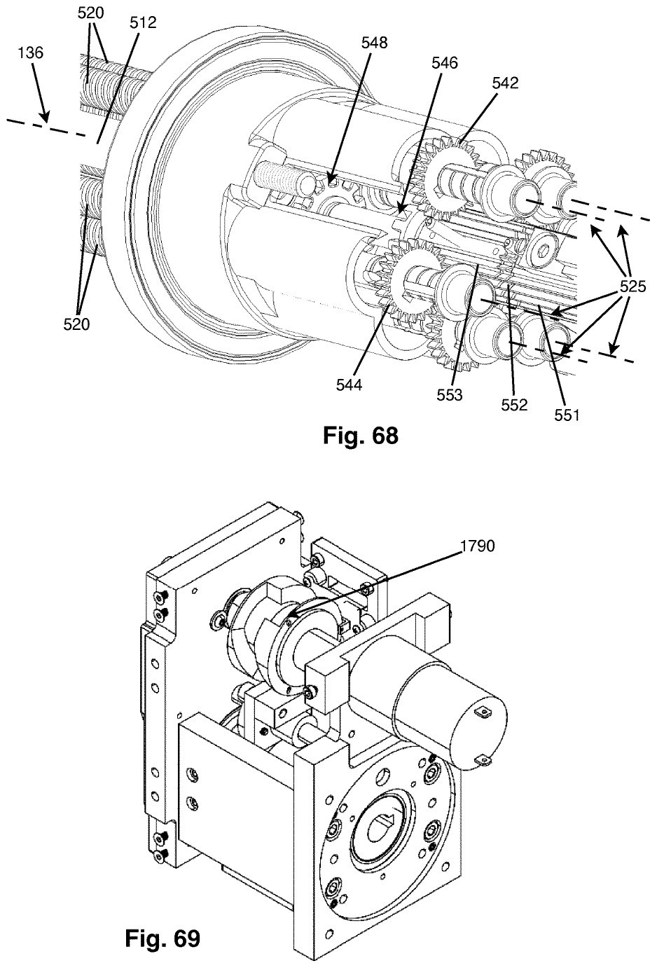

FIG. 68 is an oblique view of a close-up portion of the drive shaft assembly of FIG. 65 with cover of the clutch removed;

FIG. 69 is a perspective view of a clutch features a linear movement rotating cam acting as the mechanism for the transition of operating modes in accordance with an embodiment.

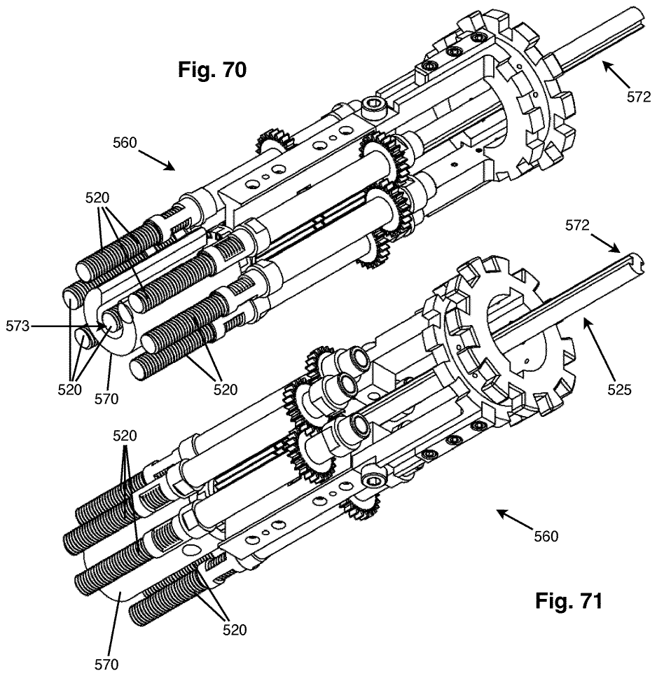

FIG. 70 and FIG. 71 are perspective views of a shaft clutch without covers connected to a split drive shaft and leadscrew in accordance with an embodiment;

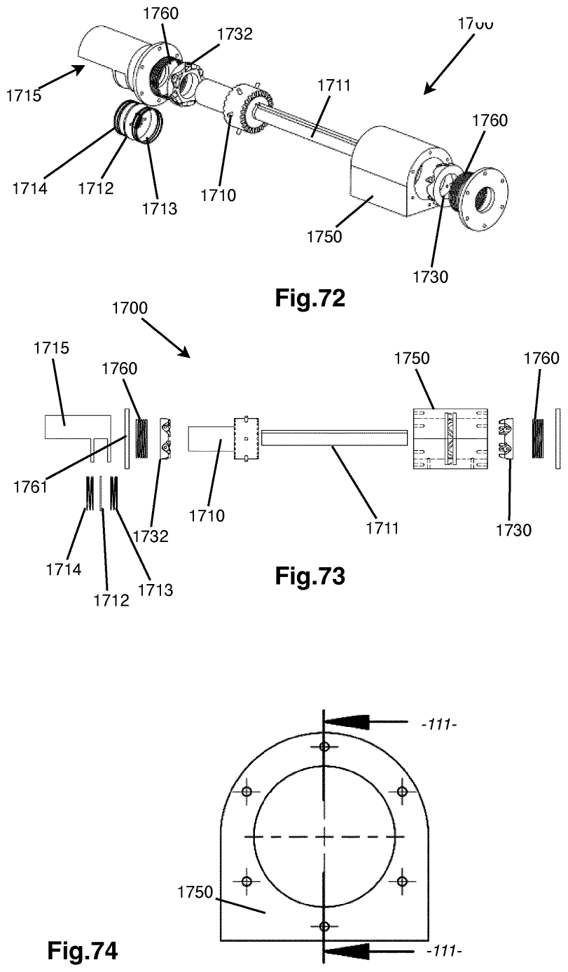

FIG. 72 is a perspective view of a shaft clutch in accordance with an embodiment;

FIG. 73 is a side exploded view of the shaft clutch of FIG. 72;

FIG. 74 is a front view of the external component of the shaft clutch of FIG. 72;

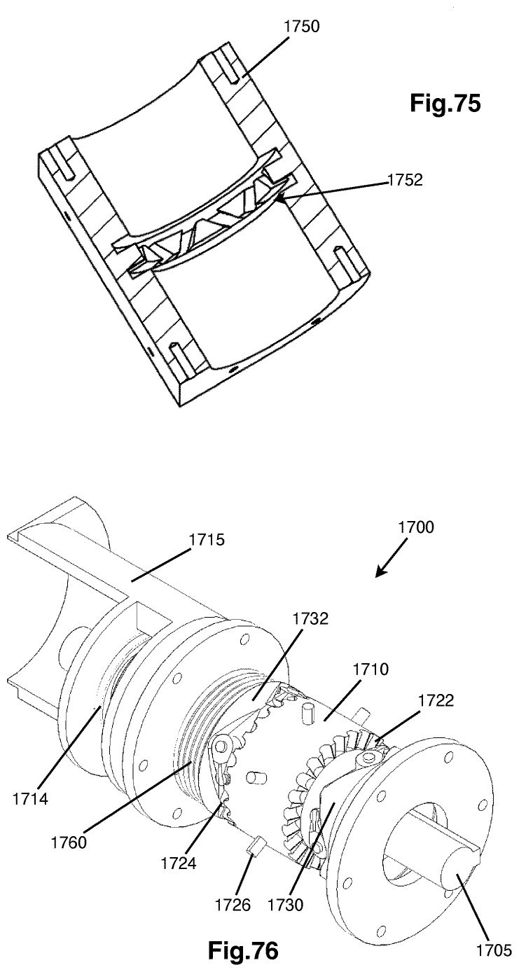

FIG. 75 is a perspective cross-section view of the external component of the shaft clutch of FIG. 72 according to lines 111-111 of FIG. 74;

FIG. 76 is a perspective view of internal components of the shaft clutch of FIG. 72;

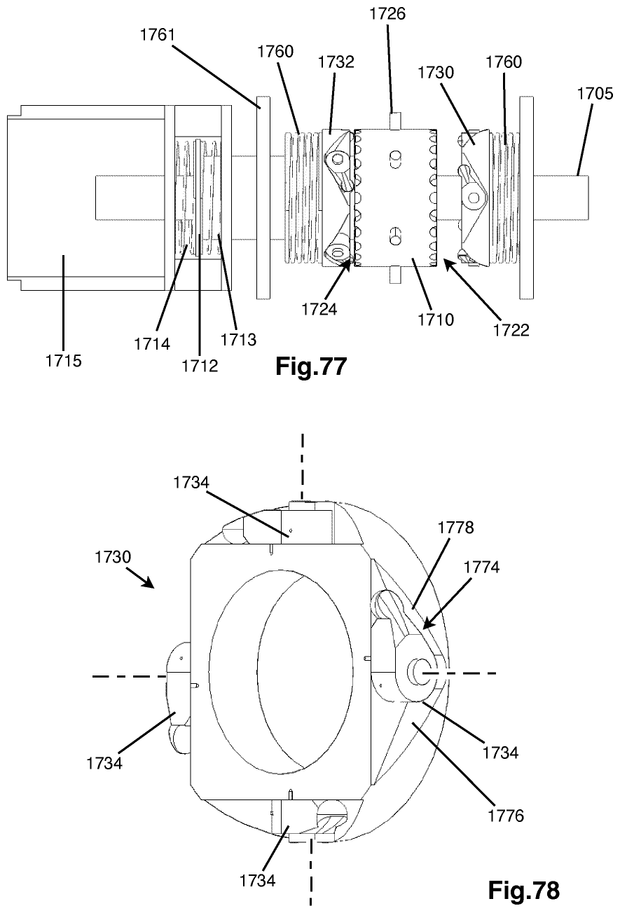

FIG. 77 is a side view of the internal components of the shaft clutch of FIG. 72;

FIG. 78 is an oblique perspective view of a cam disk of the shaft clutch of FIG. 72;

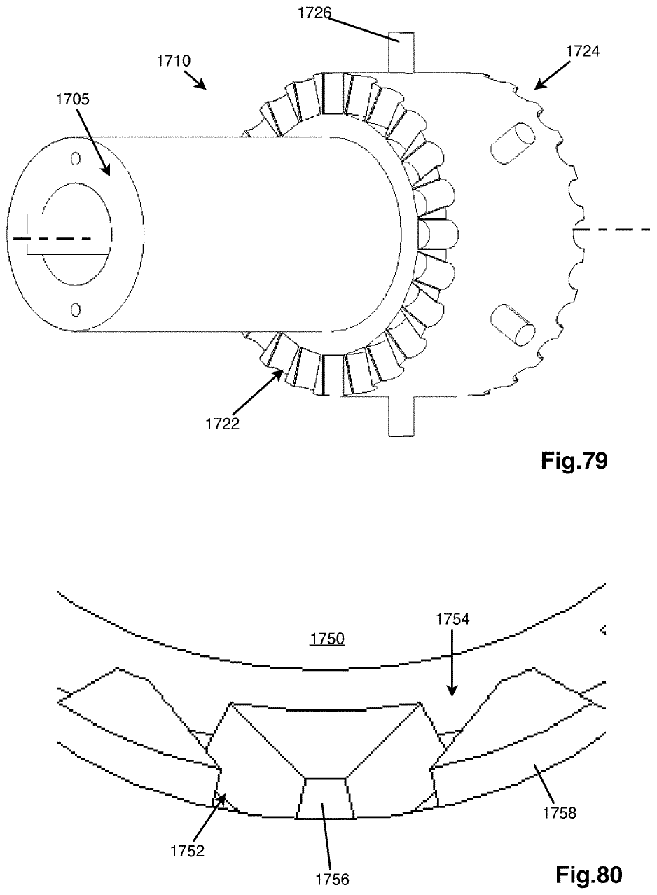

FIG. 79 is an oblique perspective view of the core component of the shaft clutch of FIG. 72;

FIG. 80 is a perspective view of a portion the external component of the shaft clutch of FIG. 72;

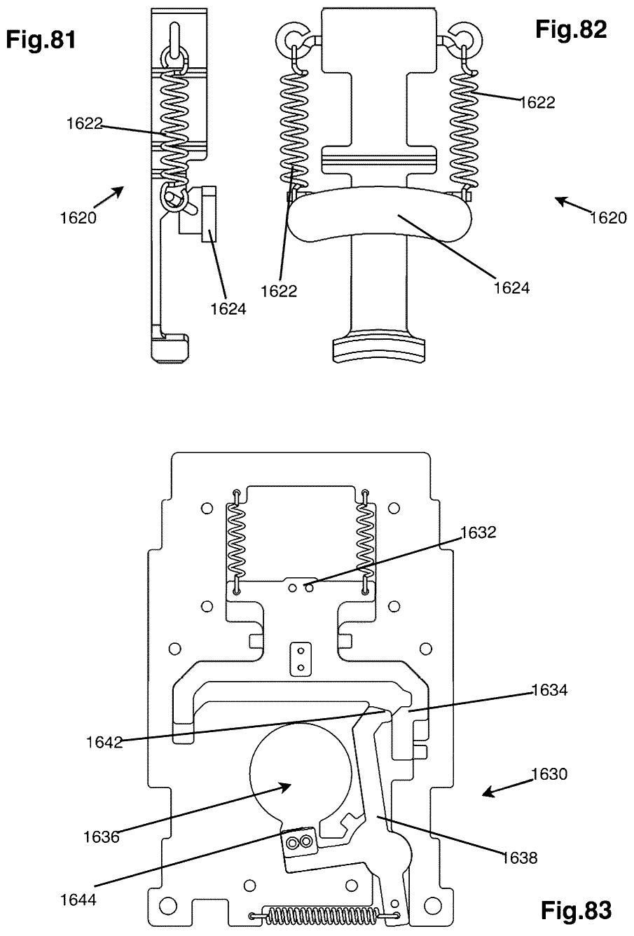

FIG. 81 and FIG. 82 are respectively a side view and a front view of a rotor locking mechanism in accordance with an embodiment;

FIG. 83 is a front view of a latching mechanism in accordance with an embodiment;

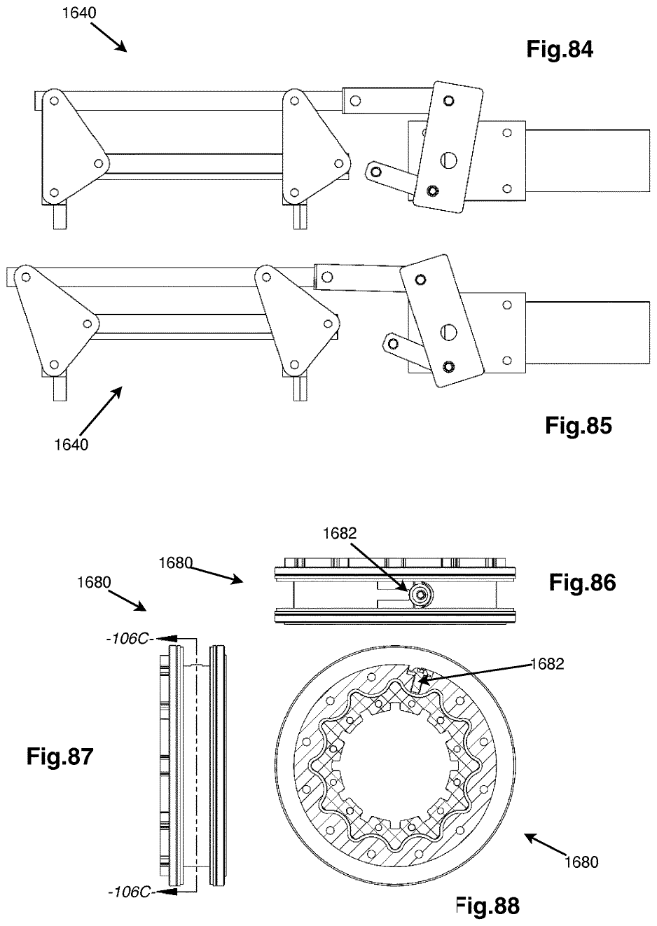

FIG. 84 and FIG. 85 are side views of a component of a rotor locking mechanism respectively is a first position and in a second position in accordance with an embodiment;

FIG. 86, FIG. 87 and FIG. 88 are respectively a perspective view, a side view and a cross-section view according to cross-section lines 106C-106C of a rotor adapted for a cable to be coupled thereto in accordance with an embodiment;

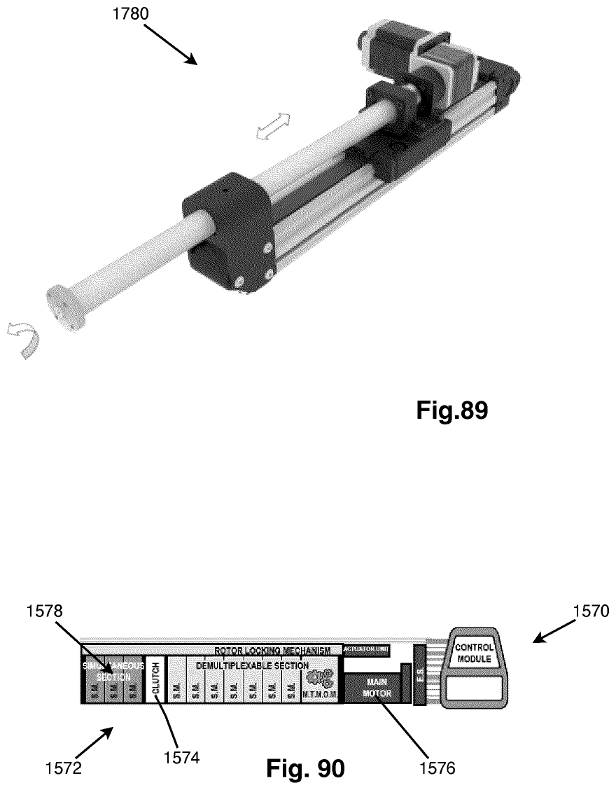

FIG. 89 is a perspective view of a roto-linear actuator in accordance with an embodiment;

FIG. 90 is a schematic of a mechanical demultiplexer with a clutch mechanism coupling the drive shaft to a second drive shaft in accordance with an embodiment;

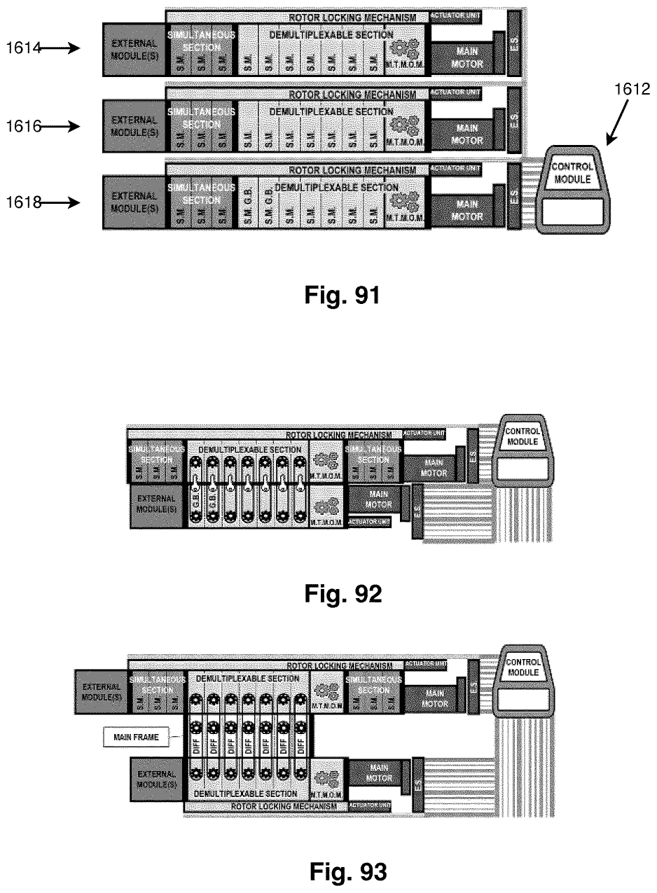

FIG. 91 is a schematic of a plurality of mechanical demultiplexers with a controller coupled thereto offering redundancy in accordance with an embodiment;

FIG. 92 is a first schematic of a plurality of mechanical demultiplexers with coupled the common output modules in accordance with an embodiment;

FIG. 93 is a second schematic of a plurality of mechanical demultiplexers with differential components coupling the output modules of the mechanical demultiplexers a combination of outputs of output modules of the two mechanical demultiplexers in accordance with an embodiment;

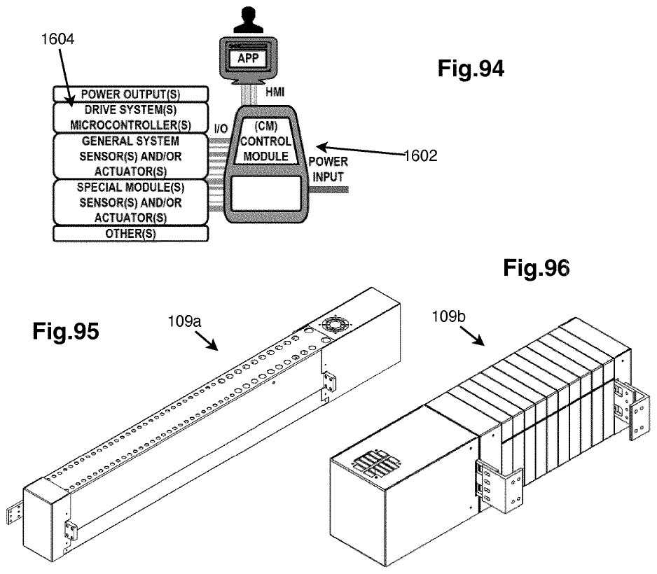

FIG. 94 is schematic depicting a controller to be coupled to a demultiplexer in accordance with an embodiment;

FIG. 95 and FIG. 96 are perspective views of casings used for a mechanical demultiplexer in accordance with an embodiments;

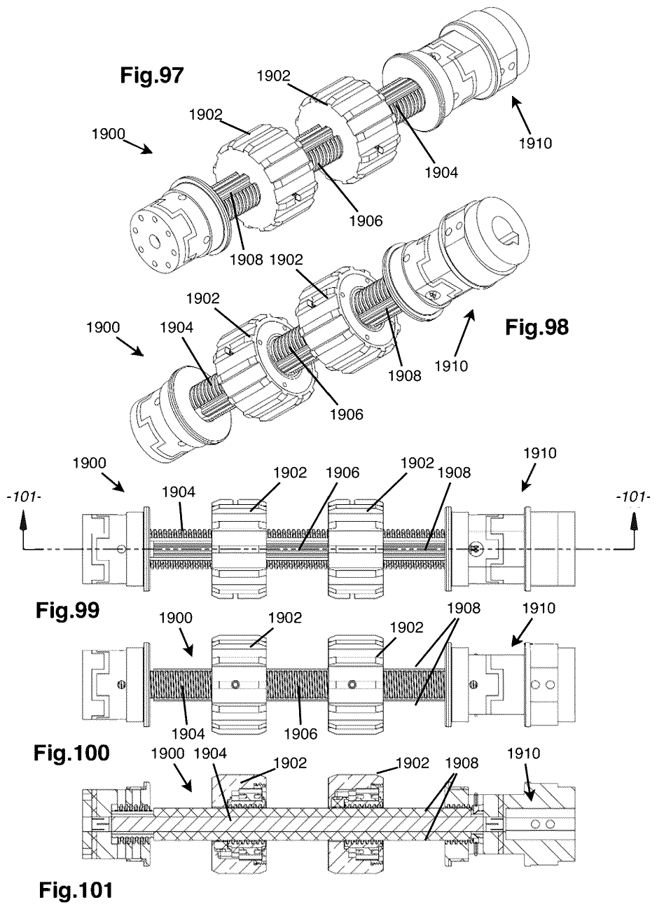

FIG. 97 and FIG. 98 are perspective views of a drive shaft assembly according to an embodiment;

FIG. 99 is a top view of the drive shaft assembly of FIG. 97;

FIG. 100 is a side view of the drive shaft assembly of FIG. 97; and

FIG. 101 is a cross-section view of the drive shaft assembly of FIG. 97 according to lines 103-103 on FIG. 99.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

In the following description, it is understood that terms such as “first”, “second”, “top”, “bottom”, “above”, “below”, and the like, are words of convenience and are not to be construed as limiting terms.

It should further be noted that for purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It should be further noted that for the purpose of this disclosure, the term “structure” means any piece of combination of pieces coupled together.

It should be further noted that for the purpose of this disclosure, the term “element” means any portion of a piece, a piece, or a combination of pieces respecting the associated function.

Technology described below relates to the field of automation, mechatronics and connected industrial equipment. There is described a modular mechanical transmission system, powered by one servomotor where each added module becomes in itself a virtual servomotor. This modular mechanical transmission system is also referred to as a mechanical demultiplexer. This term refers to the demultiplexer in information technology and alike wherein a single data input is distributed into a multitude of different outputs.

Described mechanical demultiplexer allows to connect a drive system comprising a motor with all functional components allowing operation of a multitude of output modules that can operate individually and/or simultaneously. and standard mechanical power and position transmission components, hereinafter generally called transmission components, such as but not limited to gear and timing pulley, in a simultaneous section; occupying less space through stacking of output modules; designing modular and flexible systems by stacking a combination of output modules with different final output mechanisms; decreasing the manufacturing and assembly costs; decreasing assembly costs of complete electromechanical systems through pre-assembled output modules; and allowing a third party to use output modules designed for the mechanical demultiplexer for customized needs.

It is further advantageous to have a compact system wherein length required for the system is almost fully occupied by powering subsystem and output modules, with engaging and disengaging require no additional length or extension of the drive shaft powering output modules.

Practically, it allows to modulate input power, thus driving motor, to respond to the maximum output requirements of a sequence of operations to be performed by the output modules rather than the sum of power input requirements of the sum of output modules, since the input power may be programmed to simultaneously power a maximum subset of output modules regardless of the number of output modules releasably coupled thereto to perform the sequence of operations.

### Purpose of Mechanical Demultiplexers

Purposes of mechanical demultiplexers are to perform a plurality of tasks using a single drive system.

According to an embodiment, mechanical demultiplexers are the structure on which can be coupled modules for performing tasks.

According to an embodiment, mechanical demultiplexers, with a single mechanical power input, can provide a plurality of types of mechanical outputs.

According to alternative embodiments, mechanical demultiplexers can sum up a plurality of mechanical inputs connected through a mechanism allowing one mechanical input to operate at a time, or alternatively be considered selectively summable to power output modules.

Referring generally to FIG. 1, FIG. 2 and FIG. 3, mechanical demultiplexers can comprise a plurality of different subsystems of different functionalities. According to a general embodiment, mechanical demultiplexers comprise a frame, and a motorized drive shaft coupled to the frame, and extending along a drive axis defining a longitudinal direction. Mechanical demultiplexers further comprise transmission nut(s) mounted to the drive shaft, wherein the transmission nuts are drivable by the drive shaft. Mechanical demultiplexers further comprise output module(s) mounted to the frame, with the drive shaft extending across the output modules. The drive shaft is controllably engageable to the output module(s) through transmission nut(s), therefore allowing to controllably power the output module(s). Accordingly, mechanical demultiplexers are adapted to engage selectively output module(s).

When a plurality of output modules are part of a mechanical demultiplexer, transmission nut(s) allow to engage selectively a number of output modules, thereby allowing to have a variable number of output modules being driven, and the output modules being individually drivable regardless of position on the frame, but rather limited by the number and characteristics of the transmission nuts engaging the output modules.

Therefore, embodiments of mechanical demultiplexers of the present description can be powered by a single motor, with a compact footprint defined by the frame necessary to mount the drive shaft, its motorization and the output modules drivable by the drive shaft.

Embodiments of mechanical demultiplexers are modular, allowing to mount a variety of output modules to the frame based on the operations to be performed by the mechanical demultiplexers, and to easily retrofit the mechanical demultiplexer in the future by simply adding, or replacing output modules.

Embodiments of mechanical demultiplexers further provide complete disengagement of the output module(s) from the drive shaft when not engaged. Embodiment of demultiplexers feature module-embedded locking mechanism preventing output module(s) to counterwork or react to system conditions, e.g., a piece rotating, a pump working, when a transmission nut is not engaged to the output module.

Embodiments of mechanical demultiplexers further provide flexibility in angular positioning of the drive shaft when a transmission nut engages an output module, improving operability over known mechanisms of control of multiple e.g., pumps.

These features and advantages will become more patent in light of the following exemplary description supported by graphical illustrations.

Referring to FIG. 1, FIG. 2 and FIG. 3, mechanical demultiplexer 100 comprises a frame 105 and a motorization system 110 comprises a motor 112 or other power input powering a drive shaft 130. In an embodiment, the motorization system 110 comprises a shaft clutch 120 operable in at least two positions.

The frame 105 defines a space in which the drive shaft 130 extends according to a drive axis 136. The frame 105 may be divided in compartments, namely a motorization section 102 and a powered section 107, with the drive shaft 130 extending from the motorization section 102 throughout the powered section 107. At the extremities of the powered section 107 are mounted braces 108 providing support and alignment to the drive shaft 130.

Referring particularly to FIG. 4A, FIG. 4B and FIG. 4C, it is noted that according to an embodiment, frame 105 features equidistant fingers 103 or slots 106 designed to provide alignment and guide into mounting output modules thereon at designed locations and with designed clearance in-between.

Referring to FIG. 95 and FIG. 96, casing 109a and 109b, encompassing modular casings, may be used instead or in combination with the frame 105. Thus, a support structure is therethrough contemplated as a frame.

Referring additionally to FIG. 5, transmission nut(s) 150 are mounted to the drive shaft 130. Transmission nut(s) 150 are drivable longitudinally along the drive shaft 130, movable between, e.g., free locations that are free of output modules 170 and engaging locations wherein transmission nut(s) 150 are set in contact with at least one output module 170, thereby when powered by the drive shaft 130 powering the output module(s) 170.

According to embodiments, the drive shaft 130 comprises a powering element able to transmit rotation to the transmission nut around the drive axis; a leading element able to exert the transmission nut to travel along the drive axis; and a guiding element able to allow linear translation of the transmission nut relative to the drive axis without rotation. In ab an embodiment, the power-transmission element 132 comprises a pair of eccentric shafts coupled to a shaft clutch 120 through driving plate 125. The nut-driving element(s) 134 are leadscrews 138 each one adapted to drive a driven transmission nut 150, and to pass through other non-driven transmission nuts 150, e.g., other transmission nuts, such that when driven, a leadscrew 138 exerts the driven transmission nut 150 to move longitudinally along the drive shaft 130 parallel to the drive axis 136. Based on the location of the driven transmission nut 150 along the drive shaft 130, thus either or not in contact with an output module 170, when the eccentric shafts 137 will rotate around the drive axis 136, the transmission nuts 150 will be forced to pivot around the drive axis 136 as well, and if in contact with an output module 170, will power the output module.

According to embodiments, the drive shaft may take many forms, including a split shaft with a co-axial leadscrew, a number of parallel leadscrews, a leadscrews combined with guiding elements, a non-cylindrical shaft with busbars, e.g. a spline leadscrew aka a spline threaded shaft, etc.

In an embodiment, as depicted particularly on FIG. 5, the transmission nuts 150 feature a threaded bore 152 adapted to interface with the threads 139 of a driving leadscrew 138 (voluntarily hidden), and oversized bore(s) 154 having a diameter greater than the outside diameter of the threads 139, allowing a leadscrew 138 passing through an oversized bore 154 to be driven without the leadscrew 138 forcing the transmission nut 150 to move longitudinally.

Transmission nuts 150 feature an outward non-cylindrical surface, e.g., a spline 156, e.g., comprising at least one longitudinal groove, allowing the transmission nut 150 to interface with a complementary inward spline 172 of an output module 170. Interface between the splines 156 and 172 allows powering the output module 170. Accordingly, transmission nuts 150 may be longitudinally moved across output modules 170, e.g., moved between a position on the drive shaft 130 left to a first output module and a position on the drive shaft 130 right to the first output module 170, e.g., free of engagement or engaged to another output module. This allows with a single transmission nut 150 to power selectively and individually a plurality of output modules 170. Furthermore, based on distance between output modules 170 and the longitudinal length of the transmission nut 150, thus its longitudinal spread, a transmission nut 150 may power more than a single output module 170, when moved to be in contact with two output modules 170, in other words transmission nuts 150 may be moved such that the powering length, aka longitudinal distance between extremities of the outward spline 156 of the transmission nut 150, is spread over more than the gap between the inward splines 172 of two neighbor output modules 170.

Referring additionally to FIG. 6, the shaft clutch 120 is movable between at least two positions:—a first position, also called powering position, resulting, when the motor 112 is working, in the driving plate 125 pivoting, thus powering all output modules 170 engaged to the drive shaft 130 through a transmission nut 150; and—a second position, also called moving position, wherein the driving plate 125 remains immobile and one of the leadscrews 138 is driven by the motor 112, controllably driving longitudinal displacement of the driven transmission nut 150 along the drive axis 136.

Accordingly, with a single powering motor 112, the mechanical demultiplexer 100 operates according to three states: a) a stop state where the motor is stopped, during which a actuator (114, FIG. 6) may change the position of the shaft clutch 120; b) a powering state when the shaft clutch 120 is in powering position and the motor 112 works thereby powering engaged output module(s); and c) a setting state the shaft clutch 120 is in moving position and the motor 112 works thereby setting transmission nut(s) to position(s) along the drive axis 136.

According to embodiments, the shaft clutch 120 can drive a single leadscrew 138 at a time when a single transmission nut 150 is threadedly engaged to a driven leadscrew 138. Moving multiple transmission nuts 150 threadedly engaged to multiple leadscrews 138 requires driving one leadscrew 138 at a time necessary to place transmission nut(s) in position.

It is contemplated therethrough that the shaft clutch 120 may take many forms without departing from the scope of the present description.

Referring to FIG. 69, an exemplary clutch features a linear movement rotating cam acting as the mechanism for the transition of operating modes. Interactions between cams 1790 control the output shaft of the clutch shifting between two positions.

It is further contemplated therethrough that even though the expression “output module” is used herein, one skilled in the art would recognize that output modules compatible with the present mechanical demultiplexers encompass any component adapted to transform mechanical power transmitted thereto by the drive shaft 130 into work of any kind, comprising mechanical work, hydraulic work, pneumatic work, positioning work, electrical work, etc. For instance, contemplated output modules may be dedicated to a specific task, action, or function, such as transmitting torque, rotational speed or angular position; may serve as an assembly platform for functions, add-ons, or rotor locking mechanisms attached to rotor(s) or stator(s); may be idle modules with locking components used to park moving transmission nut(s); may be add-ons mounted to output modules or the frame having capabilities, or aiming to help, improve, or optimize operation, performance, and reliability of tasks, actions, or functions; etc. Many examples of such output modules are provided hereinafter in Section OUTPUT MODULES.

Referring particularly to FIG. 1, mechanical demultiplexer 100 comprises a keyed shaft 175 mounted distant to and extending parallel to the drive shaft 130, coupled to the output modules 170. The keyed shaft 175 is used to exert additional conditions to the output modules.

In the embodiment depicted in FIG. 1, 2, 7 or 9, the keyed shaft 175, when pivoted between a first angle and a second angle, triggers an internal mechanism of the output modules 170 allowing, e.g., to switch the output modules 170 between an unlocked position wherein the inward spline 172 of the output module 170 is able to turn, and a locked position wherein the inward spline 172 of the output module 170 is locked, preventing the output module 170 to receive power from the drive shaft 130 or from external condition, e.g., reminder pressure/vacuum in a tube connected to a pump part of an output module 170, to exert operation of the output module 170. Furthermore, the keyed shaft 175 allows in some embodiments to set a switch, set a position, etc. over all the output modules 170 to ensure conditions are respected by all output modules 170 for e.g., entering a state, e.g., stop state.

It is worth noting that accordingly, the mechanical demultiplexer 100 may need e.g., a plurality of driving components: a powering motor 112, a clutch actuator 114 and a module-coupled actuator 116, that may be mounted on the same side of the powered section, keeping the volume and footprint of the mechanical demultiplexer 100 minimal.

It is further worth noting that in that configuration characteristics, including maximum power output of each of the motors 112, and actuators 114, 116 may differ; with the maximum power being set based on e.g., the maximum output required to lock all output modules 170, the maximum output necessary to synchronously drive a maximum number of output modules 170 considering the specific purpose of the mechanical demultiplexer 100, etc.

It is contemplated therethrough that other components may be coupled directly or indirectly to the motorized section. For instance, external components may be coupled to the free end 140, FIG. 2, of the drive shaft 130, whereby these external components are powered as whenever the drive shaft 130 is in a powering state. A clutch may be used to controllably couple/disengage the external components from the drive shaft 130. External components may also be coupled through output modules 170, thereby being indirectly powered by the drive shaft 130. Further variation in configuration, coupling alternative, etc. are thereby contemplated, without departing from the scope of the present description.

It is further contemplated that a mechanical demultiplexer 100 may comprise a plurality of powered sections 107 operating with their own drive shaft 130. Such mechanical demultiplexer 100 may have aligned drive shafts 130 extending in opposed directions, e.g., see FIG. 8, or parallel drive shaft for instance. Therefore, a variety of configurations are contemplated therethrough.

Referring to FIG. 94, a controller 1602 operated by a person, or programmed, exchange signals with, comprising controlling the components of a mechanical demultiplexer, comprising motors and actuators 1604.

Referring to FIG. 90, an exemplary embodiment features a drive shaft 1572 of a mechanical demultiplexer 1570 with a clutch 1574 mounted at the end opposed to the motor 1576. The clutch 1574 allows to selectively power a second drive shaft 1578.

Referring to FIG. 91, a unique controller 1612 controls three mechanical demultiplexers 1614, 1616 and 1618.

Referring additionally to FIG. 92 and FIG. 93, two demultiplexers may have output modules coupled to each other for different reasons, comprising redundancy, combination of work from the output modules such as addition of power, addition of output of another nature, or use of output of two output modules as a complex input for an external device.

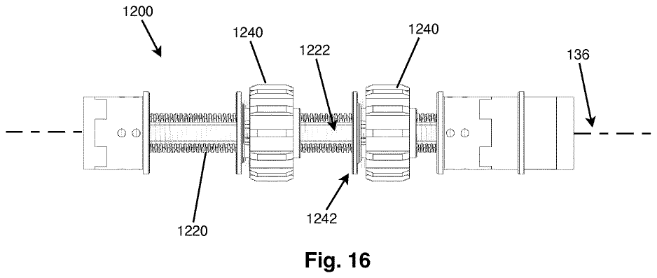

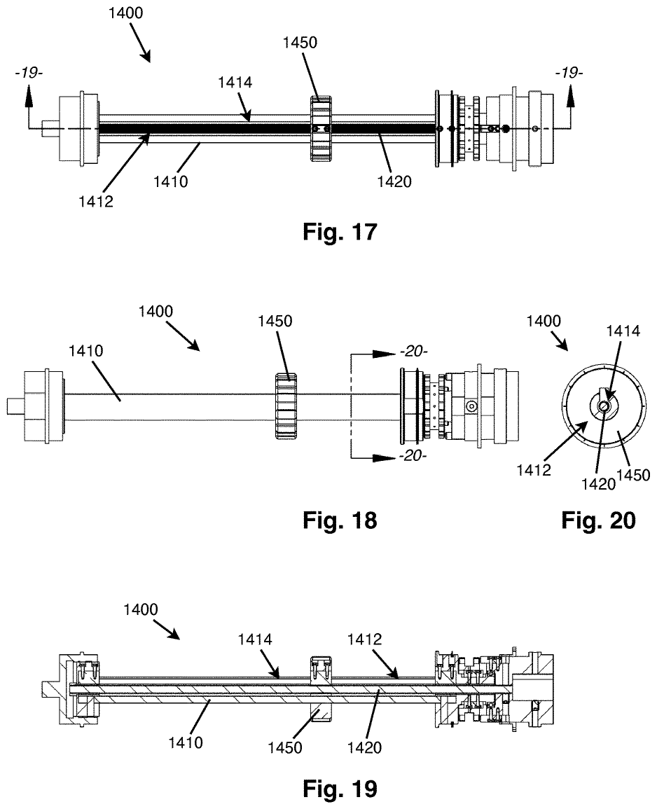

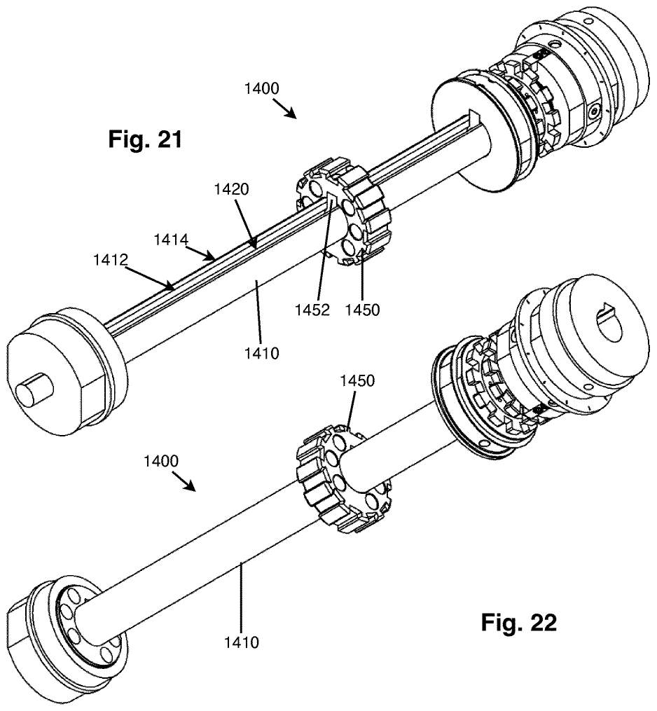

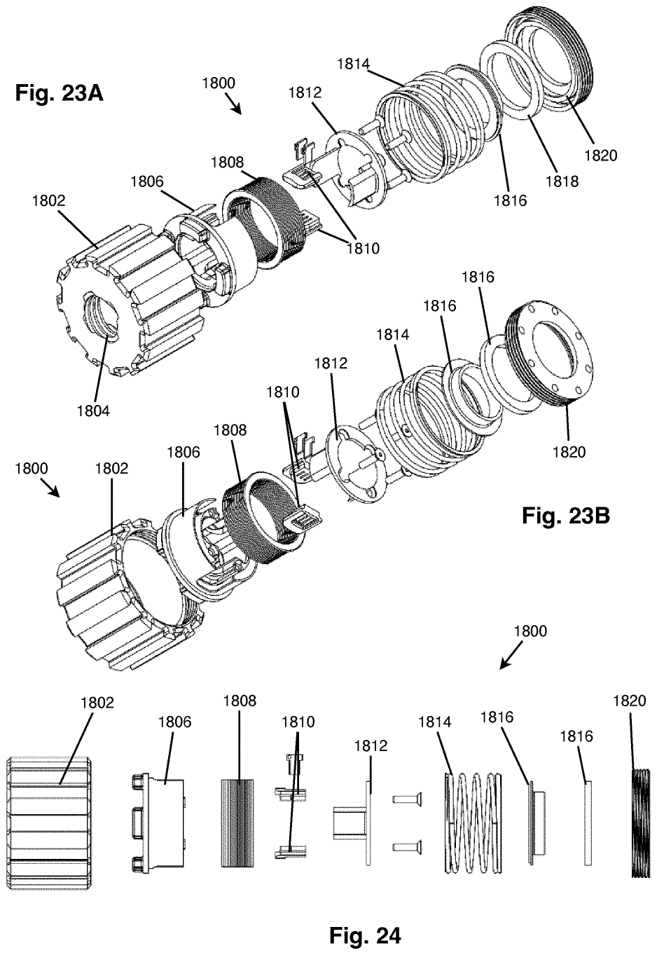

Referring to FIG. 10, FIG. 11, FIG. 23 and FIG. 24, mechanical demultiplexer 200 comprises a motorized drive shaft 230 along which extends electric busbars 232, and on which are mounted electrical transmission nuts 250 that are movable longitudinally along the drive shaft 230. The transmission nuts are powered and controlled by the electric busbars 232 to move along the threaded surface of the drive shaft 230 allowing them to engage to and disengage from output modules.

Mechanical demultiplexer 200 operates also according to three states: a) stop state; b) powering state; and c) a setting state. In powering state, the transmission nuts 250 are locked in position using an electro-magnetic locking mechanism. When the drive shaft 230 pivots, the transmission nuts 250 thereby transmit power to engaged output modules (not depicted) scattered along the drive shaft 230.

Accordingly, electric busbars 232 are used to distribute electric power to operate transmission nuts 250. At least two electric busbars 232 are present.

According to embodiments, but without limitation, an exemplary configuration of the electrical type operates with a rotor locking mechanism attached to the main frame with an electric distribution.

Referring to FIG. 5, an exemplary drive shaft comprises a combination of guiding components, e.g. 137//, and a combinations of leadscrews, e.g. 138//, to drive a number of transmission nuts thereon.

Referring to FIG. 1, FIG. 63, and FIG. 64, the shaft clutch 120 operates under power of the clutch actuator 114 driving a worm screw 115. The worm screw 115 is engaged to a spur gear 121 controllably coupled to a shaft coupling 123 through which extends at the center a drive shaft (not depicted) and eccentric are leadscrews (not depicted). The shaft clutch 120, depending on angular position of the shaft coupling 123, either drives one of the leadscrews to pivot or drives the shaft coupling 123, thereby exerting the leadscrews to rotate around the drive axis 136 without pivoting around their own axes. A sensor 127 stationary coupled to the shaft clutch 120 and coupled to a controller (not depicted), is adapted to detect angular position of the shaft coupling 123. The controller is thus adapted to provide commands to the clutch actuator 114 and the motor 112 to operate such that they do not operate at the same time, and that the motor 112 operates only with the shaft coupling 123 at the appropriate angle to yield the desired result e.g., moving a transmission nut or powering the drive shaft.

Referring now to FIG. 9, exemplary mechanical demultiplexer 300 may comprise a plurality of transmission solutions to power output modules. As example, motor 112 may power a first drive shaft 322 extending in a first direction and a second drive shaft 324 extending in the opposed direction. First shaft clutch 332 may be mounted on the first side to controllably control operation of the first drive shaft 322, and secondly, a shaft clutch 334 may be mounted on the second side to control operation of the second drive shaft 324. Thereby, the exemplary mechanical demultiplexer 300 may operate the first drive shaft 322 and the second drive shaft 324 either synchronously or not.

In the exemplary mechanical demultiplexer 300, any drive shaft may comprise a portion that may be a drive shaft comprising electric busbars for electrically controlled transmission nuts, e.g. transmission nuts 250, being mounted thereto.

It is therethrough contemplated that a drive shaft, e.g. drive shaft 322, may be divided into sequential portions 342, 344, and that a downstream portion 344 can be powered if the upstream portion 342 is powered.

It is to be noted that a plurality of drive shafts, e.g., similar to drive shaft 130, may be coupled to a single motor, with the motor driving either all drive shafts simultaneously, or using selection methods, e.g., a clutch, to selectively engage part of the drive shafts. It is further to be noted that many arrangements of drive shafts are available, from two being parallel, two being co-axial coupled directly to one another or indirectly, or two being in any alternative directions with a coupling solution between them or of the drive shaft to the motor allowing such alternative orientation. It is thereby contemplated that many variations in numbers and directions of drive shafts coupled or being able to be selectively coupled to a motor are described through the present description.

The second drive shaft 324 of the exemplary mechanical demultiplexer 300 further comprises a mechanical portion wherein a spline leadscrew 230 is adapted to drive a transmission nut 350 along the drive axis 136. A second portion of the exemplary embodiment may be permanently engaged to the first portion, where the second portion of the second drive shaft 324 is driven synchronously.

Thereby, it is contemplated the variations are available in combinations of portions of drive shafts such that some may be engageable, some may be synchronously powered, and some may be demultiplexable, or in other words allowing to controllably engage output modules mounted to these portions.

It is further to be noted that based on the nature of the power transmission used thereover, keyed shaft 175 or other setting/locking mechanism may be necessary or optional. In the exemplary mechanical demultiplexer 300, the second drive shaft 324 required use of a keyed shaft coupled to output modules (not depicted), while the first drive shaft 322 is totally free of keyed shaft.

Referring additionally to FIG. 60, FIG. 61 and FIG. 62, a drive shaft assembly is operable in a mechanical demultiplexer, such as mechanical demultiplexer 200. Drive shaft assembly comprises a slip ring 410 on which powering wires 420 are installed parallel on the outside, providing a series of electrical contacts on the outside regardless of angle of the slip ring 410. Powering wires 420 of the slip ring 410 are further connected to the inside face. Busbar 430 extends inside the support around which pivots the slip ring 410 with terminals 432 extending therethrough. Terminals 432 are configured such that each one of them contacts one of the inwardly extending wires 420 extending on the inner face of the slip ring 410. Drive shaft assembly comprises supports 452 that are the ends mounted to bearings 462 such that the drive shaft assembly may be mounted to a frame, may be aligned and may pivot freely over low friction.

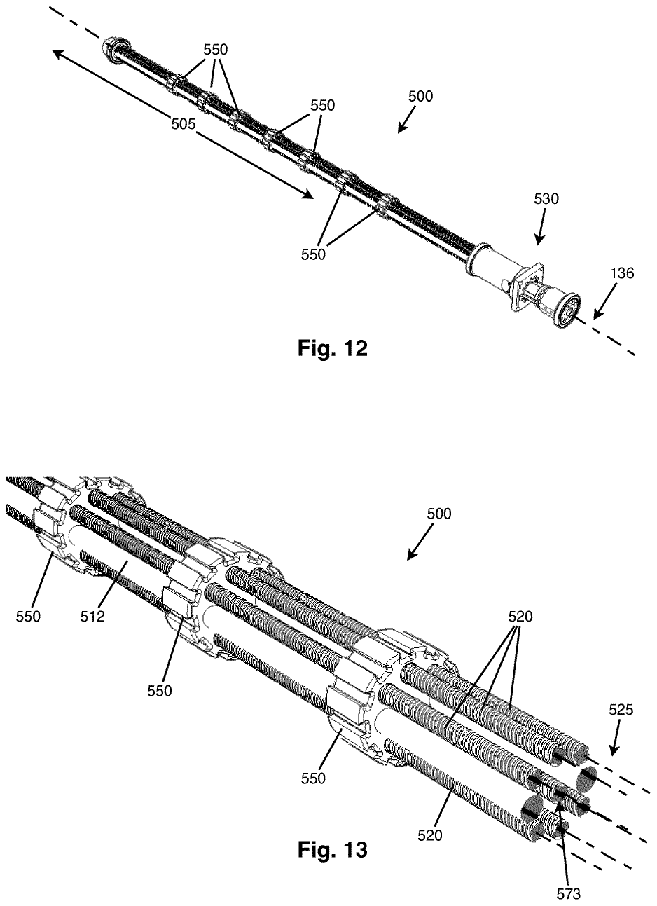

Referring to FIG. 12, FIG. 13, FIG. 65, FIG. 66, FIG. 67 and FIG. 68, another example of drive shaft is depicted therethrough. The drive shaft 500 is operable in a mechanical demultiplexer, such as mechanical demultiplexer 100. Drive shaft 500 extends along an axis 505. The drive shaft 500 comprises a guiding component(s), namely eccentric guides 512 providing a guidance for transmission nuts 550 to move along the axis 505. Drive shaft 500 further comprise leading component(s), e.g., leadscrews 520 able to drive the transmission nuts 550 along the axis 505 in both direction by pivoting around their respective lead-screw axes 525. Drive shaft 500 comprises power transmission component(s), e.g., eccentric guides 512 and leadscrews 520 adapted to rotate together around the drive axis 136 such as exerting transmission nuts 550 mounted to the drive shaft 500 to pivot, and thereby power any component(s) that may be engaged to the transmission nuts 550.

It is worth noting that many configurations are available for guiding component(s), leading component(s) and power transmission component(s). Not all of them are eccentric to the drive axis 136. Furthermore, some may be specialized, in other words having components participating in a single one of these functions, without departing from the teaching contemplated through the description. Still referring to FIG. 13, FIG. 65, FIG. 66, FIG. 67, and FIG. 68, the drive shaft 500 comprises a clutch mechanism 530 adapted to drive one or more eccentric leading components to drive one or more transmission nuts 550 along the axis 505, or a limited number, e.g. one, of central leading components to drive one or more transmission nuts 550 along the axis 505, or to drive the power transmission component(s), wherein the clutch mechanism 530 allows control of the operating state of the drive shaft 500 via a single component, and thus at a single portion of the drive shaft 500, or to free wheeling (neutral). The clutch mechanism 530 comprises a carriage dog clutch 534 comprising: a dog-clutch drive shaft locking feature 570; a lock block 554 coupled/linked to at least two sliding lock gears like 553 and 551; a cover . The clutch mechanism 530 further comprises a dog-clutch shaft coupling 532 comprising: splined shaft for sliding gears 572 with a central leadscrew dog-clutch coupling 549 at the end.

The clutch mechanism 530 further comprises one or more driving sliding gears 552 sliding along the guide for sliding gear keyed-shaft 572, as shown in FIGS. 70-71, being stuck between two sliding lock gears 551 and 553 of the dog-clutch shaft coupling 532.

The clutch mechanism 530 further comprises a dog-clutch drive shaft locking plate 555 comprising a dog clutch notch 571 that can lock the drive shaft 500 when the dog-clutch drive shaft locking feature 570 is engaged.

The clutch mechanism 530 feature a first position (drive) where the dog-clutch shaft coupling 532 is engaged with the carriage dog clutch 534, thus providing drive to the drive shaft 500.

A second free wheeling position (neutral) where the dog-clutch shaft coupling 532 is disengaged to the carriage dog clutch 534 and not driving any driving sliding gears 552.

A third position for driving the central leadscrew 573 where the central leadscrew dog-clutch coupling 549 of dog-clutch shaft coupling 532 is engaged with the central leadscrew dog-clutch 546 and where the dog-clutch shaft coupling 532 is disengaged to the carriage dog clutch 534 and not driving any driving sliding gears 552.

Many driving positions to drive one or more eccentric leadscrews 520 where the splined shaft for sliding gears 572 of the dog-clutch shaft coupling 532 transmit torque to the driving sliding gears 552 that transmit torque to an eccentric leadscrew gear 542/544. Accordingly, the drive shaft 500 provides a compact solution to combine power transmission, guidance and leading of components along the axis 505 of the drive shaft 500. It should be understood that the leading function may be applied to one or more of the transmission nuts 550 based on the number of transmission nuts 550 engaged to the same leading screw.

It should also be understood that the a leadscrew 520 can have a multiple lead-screw driving gears like lead-screw driving gears 544 and 542, thus engaging the leading function of a leadscrew 520 in multiple clutch positions according to a different embodiment.

FIG. 70 and FIG. 71 depict a similar clutch mechanism 560 adapted to drive a series of leadscrews 520 disposed around a split shaft 570 and a leadscrew 520 concentric to a split shaft 570. The similar clutch mechanism 560 is depicted without covers for the internal gears to be visible in the Figures. With this drive shaft, the guiding element is embodied through the external surface of the shaft and the groove; the leading element is embodied through the threads; and the powering element is embodied through the surfaces of the groove.

Referring to FIG. 99, FIG. 100, FIG. 101, FIG. 102 and FIG. 103, a drive shaft assembly 1900 is adapted for an electrically powered transmission nut 1902. The drive shaft 1900 comprises a spline

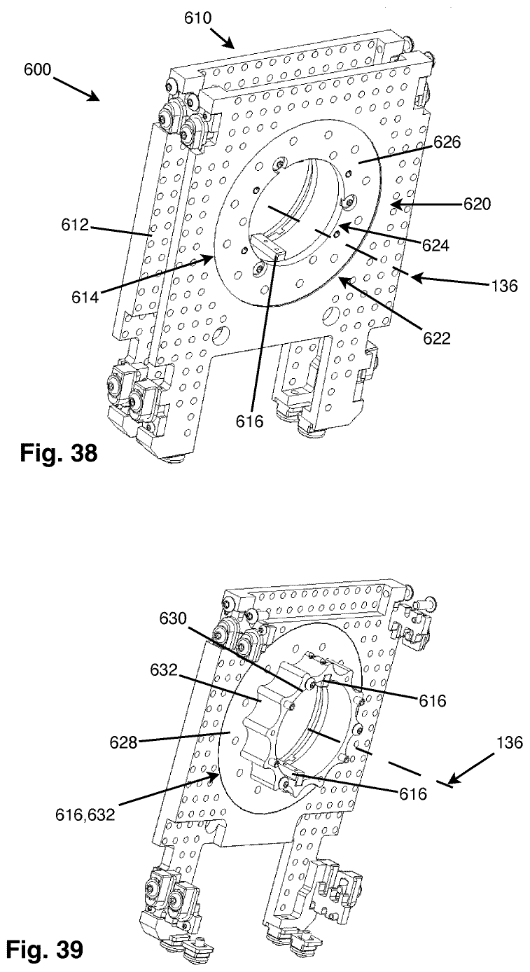

Referring to FIG. 38 and FIG. 39, a first example of output module 600 is depicted therethrough that is operable on a powering drive shaft. The output module 600, having work-specific components voluntarily omitted, comprises a stator assembly 610 and a rotor assembly 620 drivable by a drive shaft with no locking mechanism associated therewith. The stator assembly 610 is adapted to be mounted to a frame such that when the rotor assembly 620 is exerted a rotation movement, the rotor assembly 620 pivots inside the stator assembly 610 and transit power to work-specific components coupled to the rotor assembly 620.

The stator assembly 610 comprises a housing 612 with a rotor opening 614 extending thereacross for the rotor assembly 620 to freely pivot therein.

The rotor assembly 620 features an outer cylindrical face 622 adapted to interface with the housing 612 and an inner face 624 adapted to connect to e.g. a transmission nut, e.g., transmission nut 150, or directly to a shaft. In the depicted example, the inner face 624 features keys 616 adapted to interface with a spline shaft so that the spline shaft pivoting exerts the rotor assembly 620 to pivot around the shaft axis.

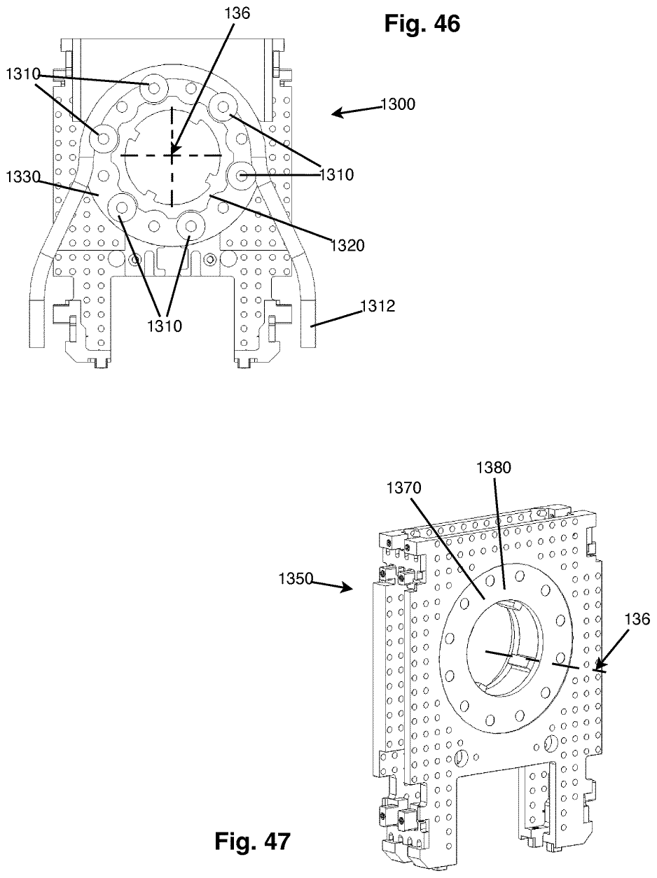

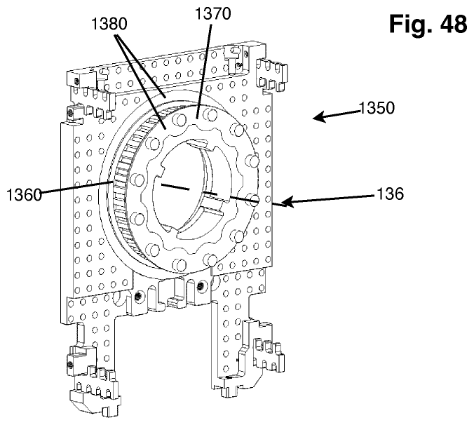

According to embodiments, the work-specific components, e.g., FIG. 46 and FIG. 48, can be mounted to the disks 626, 628 of the rotor assembly 620 or mounted to the rotating face 632 of the hub 630 of the rotor assembly 620.

Referring to FIG. 45 and FIG. 46, an output module is a peristatic pump 1300 that comprises a series of rollers 1310 designed to sequentially exert pressure over a tube 1312 when rotating around the drive axis 136 as the rotor assembly 1320 is driven by a transmission nut engaged thereto itself driven by a drive shaft. The rollers 1310 are mounted to the disks 1330 of the rotor assembly 1320.

Referring to FIG. 47 and FIG. 48, an output module is a powering device 1350 that comprises a series of teeth 1360 designed to interface with a toothed belt (not depicted) and thereby drive the belt when rotating around the drive axis 136 as the rotor assembly 1370 is driven by a transmission nut engaged thereto itself driven by a drive shaft. Pins are mounted to the disks 1380 of the rotor assembly 1370.

Through exemplary output module 1300 and exemplary output module 1350, it is thereby contemplated that variations are available in the nature of the output modules, and in the work performed by the output modules, e.g., pressure over a tube for a pumping function, and exerting a movement of a toothed belt coupled to another component transforming the movement of the belt into some work (e.g., mechanical work, pneumatic work, etc.). Therefore, it is hereby contemplated that the scope of work contemplated herein is intended to encompass a transformation of power from a pivoting shaft into any other work.

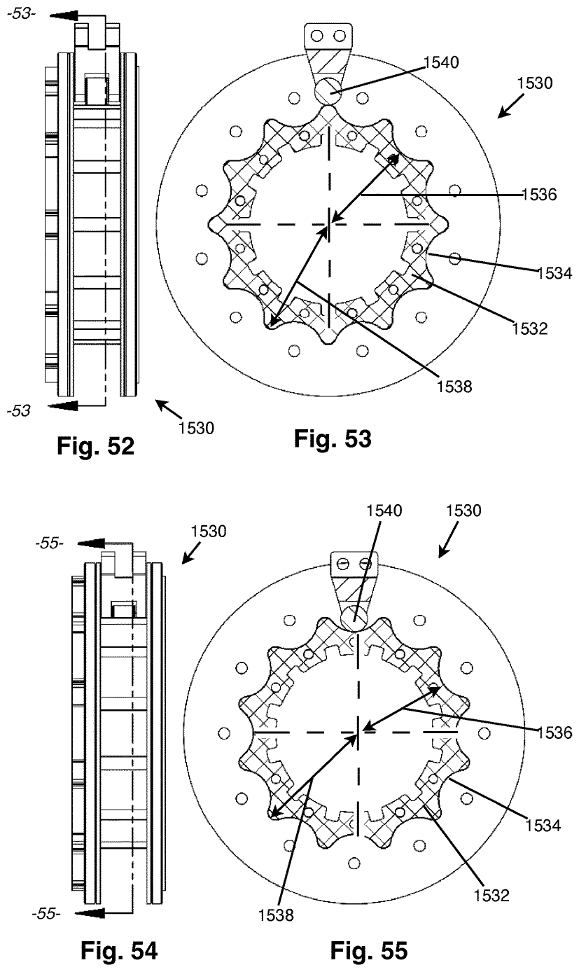

Referring to FIG. 52, FIG. 53, FIG. 54 and FIG. 55, an exemplary rotor 1530 of an output module is adapted to provide a position as the work output of being driven by the drive shaft. The exemplary rotor 1530 comprises a core 1532 having an outer face 1534 ranging between the minimum diameter 1536 and a maximum diameter 1538. A follower 1540, e.g., a roller mounted on an arm, is adapted to follow the outer face to provide a displacement following the change in the diameter of the outer face 1534.

Referring to FIG. 86, FIG. 87 and FIG. 88, an exemplary rotor 1680 of an output module is adapted for a cable (not depicted) to be coupled thereto at an anchor 1682, with motion of the rotor provided work through the cable, such as reeling the cable.

Referring to FIG. 56 and FIG. 57, an example of a rotor 1550 is thicker that the stator (not depicted) and output module which houses the rotor 1550. The rotor 1550 features a gear 1552 that is designed to pivot outside the housing provided by the rotor and to interface with a gear to provide work to an external device, wherein the work consists in rotation thereto resulting from the power transmitted by the drive shaft.

Referring to FIG. 58 and FIG. 59, a planetary gear 1560 may be coupled or part of the rotor (not depicted) of an output module. The planetary gearset 1560, through the sun gear 1562, the planetary gears 1564 and the ring gear 1566, allows to modify the revolution speed between the rotor and the output provided to the device connected to the planetary gear 1560. The revolution of the planetary gear 1560 at the modified revolution speed may in this case be considered the work output of the output module.

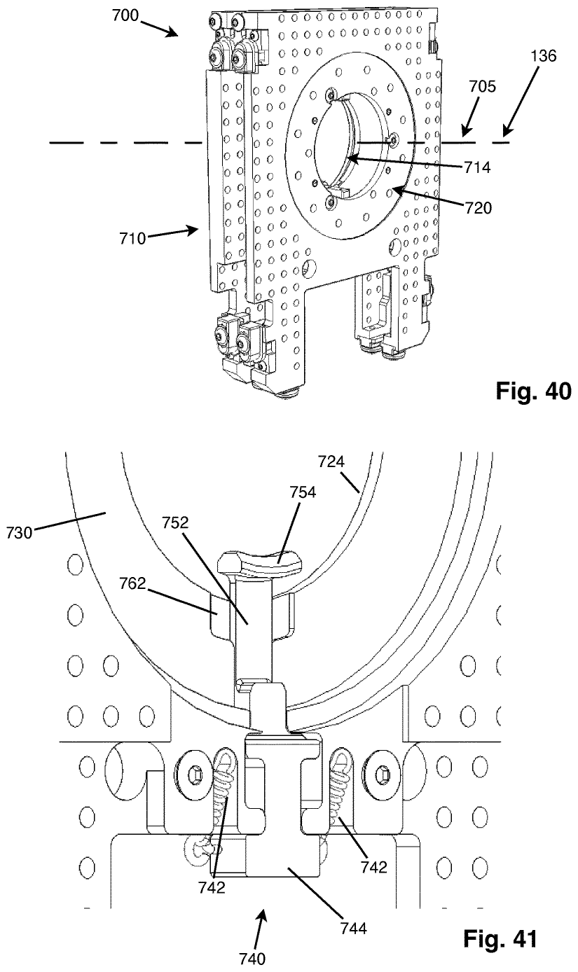

Referring now to FIG. 40 and FIG. 41, another example of output module is depicted therethrough that is operable on a powering drive shaft. The output module 700, having work-specific components voluntarily omitted, comprises a stator assembly 710 and a rotor assembly 720 drivable by a drive shaft with output module 700 comprising a nut-sensing locking mechanism 740. The stator assembly 710 is adapted to be mounted to a frame such that when the rotor assembly 720 is exerted a rotation movement, the rotor assembly 720 pivots inside the stator assembly 710 and transit power to work-specific components coupled to the rotor assembly 720.

The stator assembly 710 comprises biasing means, e.g. springs 742 that pushes biasingly a locking pin 744 toward the rotor assembly 720. The locking pin 744 comprises a pushing knob 752 having a nut-abutting end 754 having sloped faces relative to the direction of the axis 705 of the rotor assembly 720. The pushing knob 752 is biasingly abutted by the locking pin 744 resulting in the nut-abutting end 754 of the pushing knob 752 extending inwardly from the inner face 724 of the hub 730. The rotor assembly 720 further comprises a recess 762 able to house the nut-abutting end 754 of the pushing knob 752 when the pushing knob 752 is pushed by a transmission nut engaging with the output module 700. Accordingly, once a transmission nut is engaged, the nut-abutting end 754 of the pushing knob 752 becomes housed by the recess 762, and the pushing knob 752 pushes the locking pin 744 out of the rotor opening 714, allowing the rotor assembly 720 to pivot freely therein.

As soon as the transmission nut disengage from the stator assembly 710, the springs 742 force the locking pin 744 to extend in the rotor assembly 720, and the pushing knob 752 to extends beyond the inner face 724 of the rotor assembly 720.

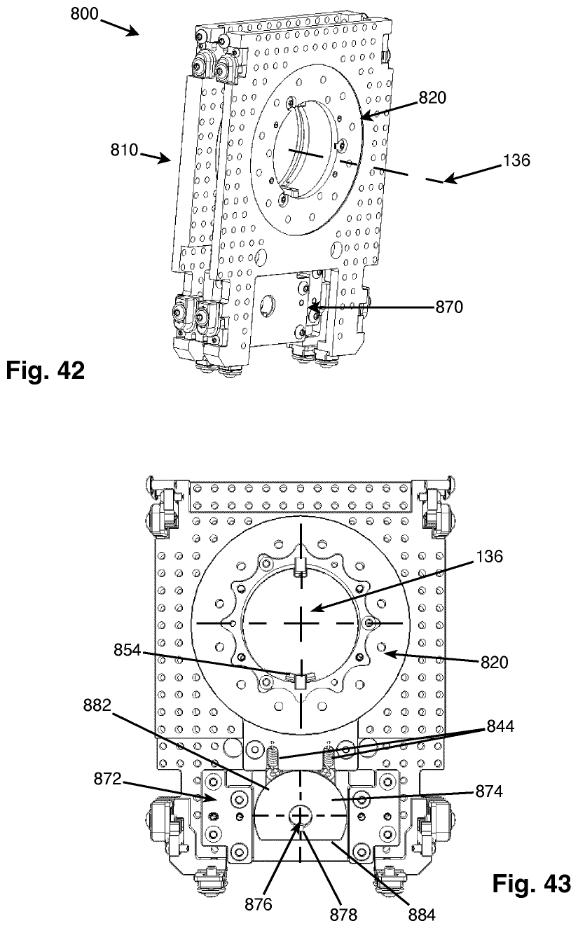

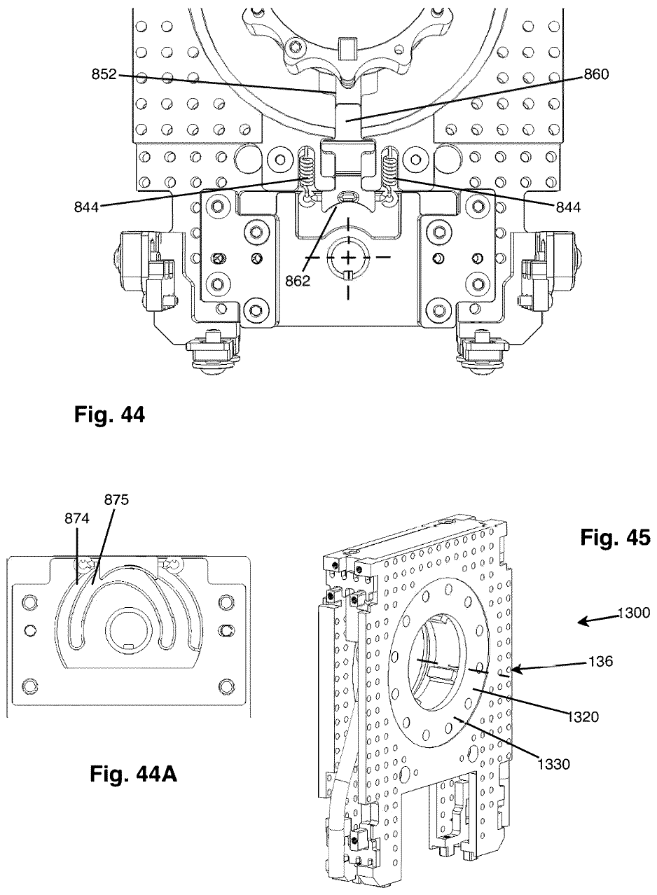

Referring to FIG. 42, FIG. 43, FIG. 44, and FIG. 44A, another example of output module is depicted therethrough that is operable on a powering drive shaft. The output module 800, having work-specific components voluntarily omitted, comprises a stator assembly 810 and a rotor assembly 820 drivable by a drive shaft with output module 800 comprising a shaft-controlled locking mechanism 870. The stator assembly 810 is adapted to be mounted to a frame such that when the rotor assembly 820 is exerted a rotation movement, the rotor assembly 820 pivots inside the stator assembly 810 and transit power to work-specific components coupled to the rotor assembly 820. FIG. 44A depicts cam 874 having a 3-way channel 875 for guiding displacement of the pin 862.

Shaft-controlled locking mechanism 870 of the output module 800 is controllable by a keyed shaft, e.g., keyed shaft 175, FIG. 1, that is controllable by an actuator. The shaft-controlled locking mechanism 870 comprises a latch mechanism 872 that comprises a cam 874 having a shaft opening 876 designed from the keyed shaft to extend across, and a key 878 designed to interface with the keyed shaft such that the keyed shaft pivoting exerts the cam 874 to pivot also.

Shaft-controlled locking mechanism 870 further comprises a locking pin 860 biasingly exerted toward the rotor assembly 820 by springs 844 comprising a locking-pin probe surface 854 and further comprising the pin 862 interfacing the 3-way channel 875 of the cam 874.

The locking pin 860 features a first locking position where the rotation of the rotor assembly 820 inside the stator assembly 810 is blocked by the locking pin 860 where a transmission nut is free to pass in the output module 800; a second locking probing position where the rotation of the rotor assembly 820 inside the stator assembly 810 is blocked by the locking pin 860 in which a transmission nut could not pass in the output module 800, thus allowing to probe a transmission nut; and a third unlocked position where the locking pin 860 provides clearance for the rotation of the rotor assembly 820 inside the stator assembly 810.

The 3-way channel 875 of the cam 874 features a first position when the cam 874 is rotated in a first direction and the pin 862 is stopped at the first cam travel end of the 3-way channel 875 securing the locking pin 680 in the first locking position; a second position with the cam 874 in the middle of the travel of the cam 874 between the first position and the third position, such that, in this position the pin 862 is free of the 3-way channel 875 and the locking pin 860 will go in the second locking probing position if no transmission nut is engaged in the output module 800 to block the movement of the locking-pin probe surface 854. The locking pin 860 is biased toward the rotor assembly 820 by springs 844, with the locking pin 860 remaining in the first locking position if a transmission nut is engaged in the output module 800, blocking the movement of the locking-pin probe surface 854 of the locking pin 860. The 3-way channel 875 of the cam 874 features a third position where the cam 874 is rotated in a second direction and the pin 862 is stopped at the second cam travel end of the 3-way channel 875 if the locking pin 860 is in the second locking probing position prior to the rotation (no transmission nut engaged), securing the locking pin 860 in the second locking probing position or the pin 862 is stopped at the third cam travel end of the 3-way channel 875, if the locking pin 860 is in first locking position prior to the rotation (transmission nut engaged), securing the locking pin 860 in the unlocked position.

Accordingly, actuated external locking is proved therethrough, with the locking state being synched between output modules 800 crossed by the same keyed shaft.

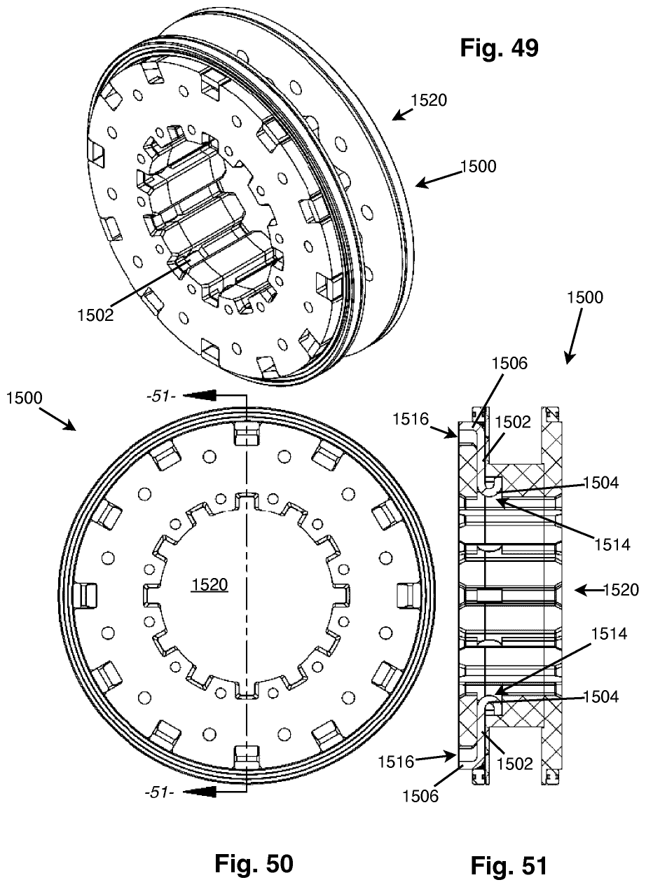

Referring to FIG. 49, FIG. 50, and FIG. 51, another exemplary embodiment of a mechanism part of a rotor locking mechanism comprises a rotating arm 1502 comprising an inward end 1504 and an outward end 1506. The rotating arm 1502 is movable in a first position wherein the locking component 1502 is pushed outward, the inward end 1504 taking place in a recess 1514 free the passage 1520 inside the rotor 1500. The rotating arm 1502 is further movable between a second position depicted through Fig. FIG. 49 FIG. 50 FIG. 51 wherein the locking component 1502 is pushed inward, the outward end 1506 taking place in a recess 1516 partially blocking the passage 1520 inside the rotor 1500.

Referring to FIG. 81 and FIG. 82. a passive solution may be used as a locking mechanism, e.g., a spring-biased friction plate mechanism 1620 comprising springs 1622 coupled to a friction plate.

Referring to FIG. 83, FIG. 84 FIG. 85, another locking mechanism comprises a latching mechanism 1630 mounted in the output module (not depicted) and an external actuation mechanism 1640 mounted outside the modulates and adapted to selectively penetrate the output modules to press the plate 1632 so that the fork 1634 is pushed toward the passage 1636 of the rotor. A spring-biased arm 1638 features a hook portion 1642 at one end interfacing with the fork 1634, and an abutting portion 1644 at the other end able to extend inside the passage 1636. Such mechanism allows to control with limited fore required when a locking occurs.

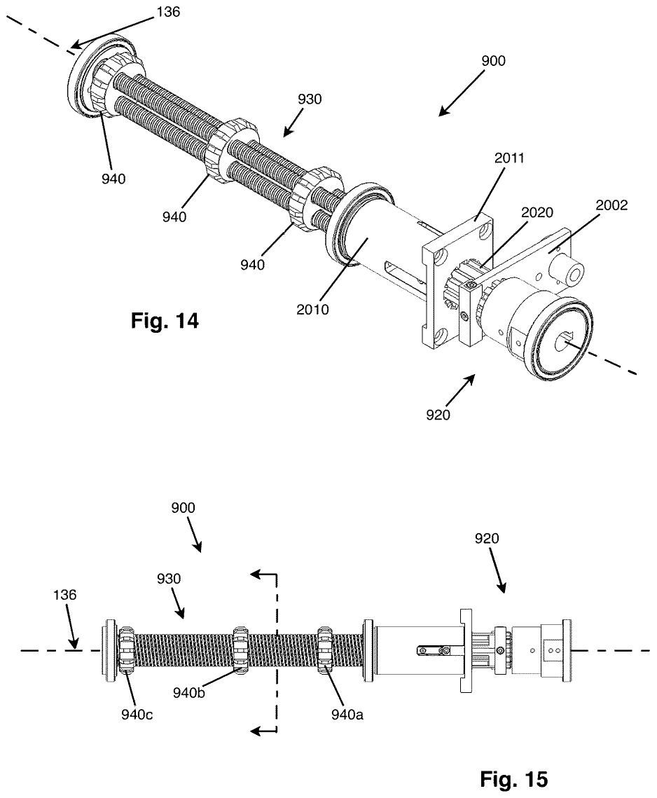

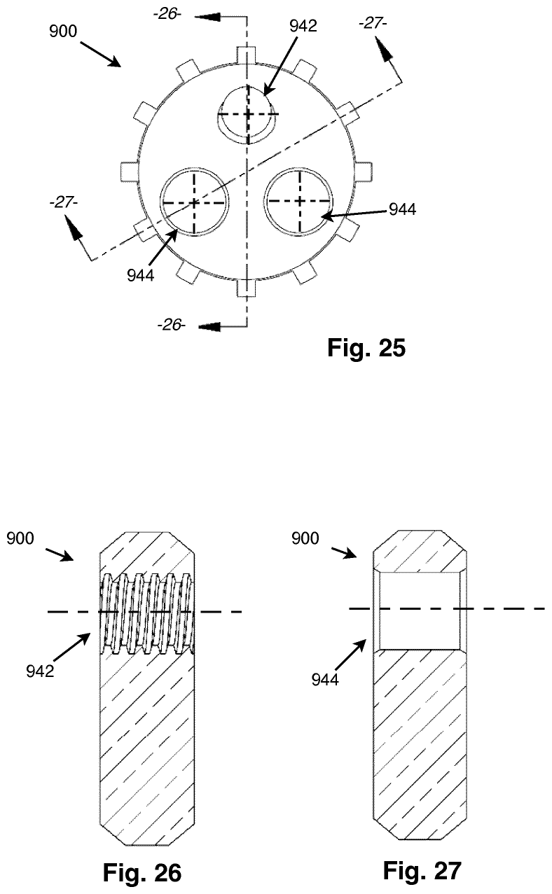

Referring to FIG. 14, FIG. 15, FIG. 25, FIG. 26 and FIG. 27, an example of drive shaft assembly 900 uses a common elements accomplishing the functions of guiding component(s), leading component(s) and power transmission component(s). FIG. 15 depicts a perspective view of the drive shaft assembly 900, and a side view of the drive shaft assembly 900.

FIG. 14 shows a dog clutch fork 2002, a gearbox 2010 comprising slots, and a lock plate 2011 interacting with the dog clutch 2020. Dog clutch mechanisms illustrate therethrough and illustrated on other figures, through controls, allow to selectively drive, e.g., make them rotate, according to embodiments, leadscrews, or the whole drive shaft.

The drive shaft assembly 900 is motorized by a motor (not depicted) and comprises a clutch 920 allowing to controllably motorize any of the three leadscrews 930 which are mounted transmission nuts 940 each comprising a threaded bore 942 coupled to a driving leadscrew 930 and oversized bores 944 coupled to other leadscrews 930 performing a guiding function over the transmission nut 940.

Through these exemplary embodiments, it is contemplated once again that variations are available in elements performing functions of guiding component(s), leading component(s) and power transmission component(s). It is further contemplated that one component may perform all of the three functions based on the current state of operation of the drive shaft assembly 900. With this drive shaft, the guiding element is embodied through the threads of the leadscrews; the leading element is embodied through the threads of the leadscrews; and the powering element is embodied through the threads of the leadscrews.

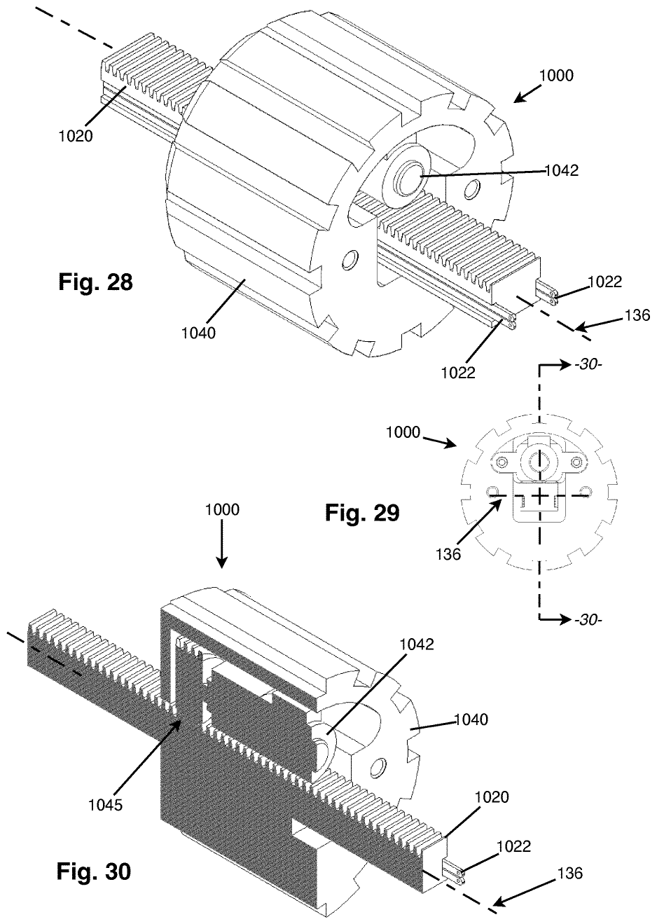

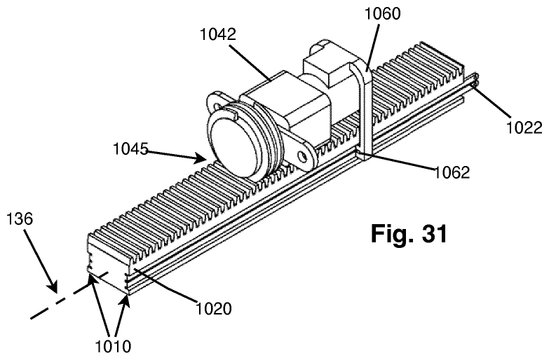

Referring to FIG. 28, FIG. 29, FIG. 30, and FIG. 31, an example of drive shaft assembly 1000 uses a step motor 1042 to drive the transmission nut 1040 along a rack 1020 part of a worm drive 1045. In that exemplary embodiment, the leading component, the step motor 1042, is integrated in the transmission nut 1040.

In the exemplary drive shaft assembly 1000, the rack 1020 performs guiding function and power transmission function. The step motor 1042 powered through the busbars 1022 mounted on both sides of the rack 1020, performs the leading function, leading the transmission nut 1040 to move along the rack 1020 as the worm drive 1045 runs. With this drive shaft, the guiding element is embodied through the 3 non-toothed surfaces of the shaft ; the leading element is embodied through the teeth of the drive shaft; and the powering element is embodied through 3 non-toothed surfaces of the shaft.

Visible on FIG. 31, the motor 1042 is mounted to the rack 1020 using a mounting component 1060 ending with terminals 1062 coupling the step motor 1042 to the busbars 1022. The mounting component 1060 extends on sides of the 1020 with the terminals penetrating the grooves 1010 in which the busbars 1022 are housed. Such configuration provides the guidance to the step motor 1042 such that when the worm drive 1045 operates the step motor 1042 travels along the drive axis 136. Referring to FIGS. 10, 11 and 16, with this drive shaft, the guiding element is embodied through the external shape of the transmission nut; the leading element is embodied through the threads of the spline leadscrew; and the powering element is embodied through the spline.

Referring to FIG. 23A, FIG. 23B and FIG. 24, the figures depict a transmission nut 1800 that is adapted to be mounted to an electric spline leadscrew. The transmission nut 1800 is operating such that when not powered, the transmission nut 1800 is longitudinally static over the electric spline leadscrew. When powered, a clutching mechanism allows the transmission nut 1800 to travel along the drive axis. The transmission nut 1800 comprises a frame 1802 comprising inner threads 1804 interfacing with the threads of the spline leadscrew; a transmission nut core 1806 and flange 1812; a spring 1808; connectors 1810; a spring 1814; a bearing 1816; a permanent magnet 1818; and a cap 1820 screwable to the frame 1802.

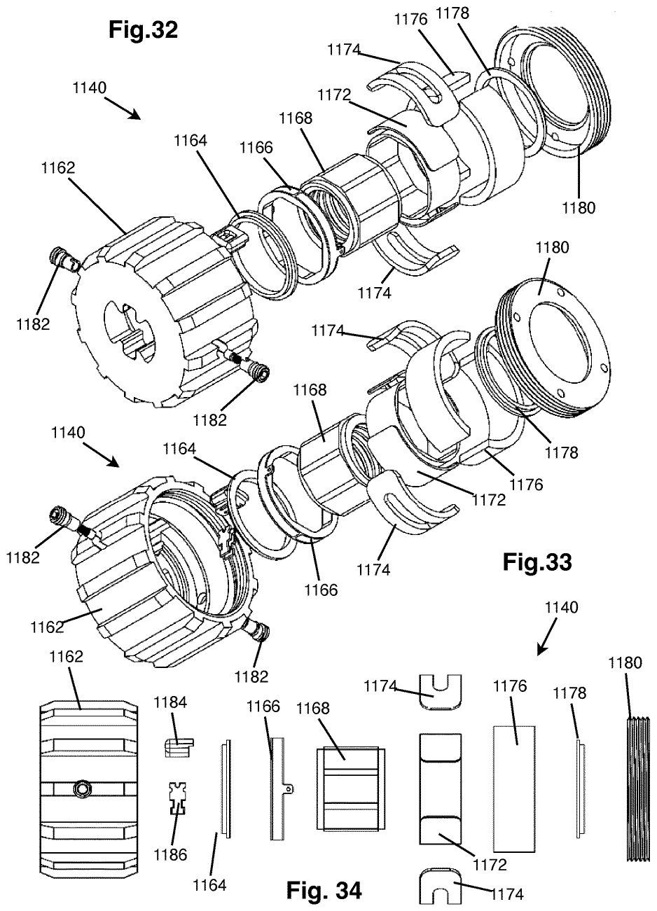

Referring to FIG. 32, FIG. 33 and FIG. 34, an example of drive shaft assembly uses a magnetic motor to drive the transmission nut. The transmission nut 1140 comprises electric connectors and magnetic components adapted to exert rotation of the threaded core, thereby driving the transmission nut 1140 to move along the drive shaft.

Referring particularly to FIG. 32, FIG. 33, and FIG. 34, the transmission nut 1140 comprises a body 1162, a bushing 1164, a connector support 1166, a core 1168, 1172, 1174 a magnet 1176, a bushing 1178, and a transmission nut element 1180. Transmission nut 1140 further comprises connector support 1184 and connectors 1186 Securing elements 1182 are used to secure the components of the transmission nut 1140.

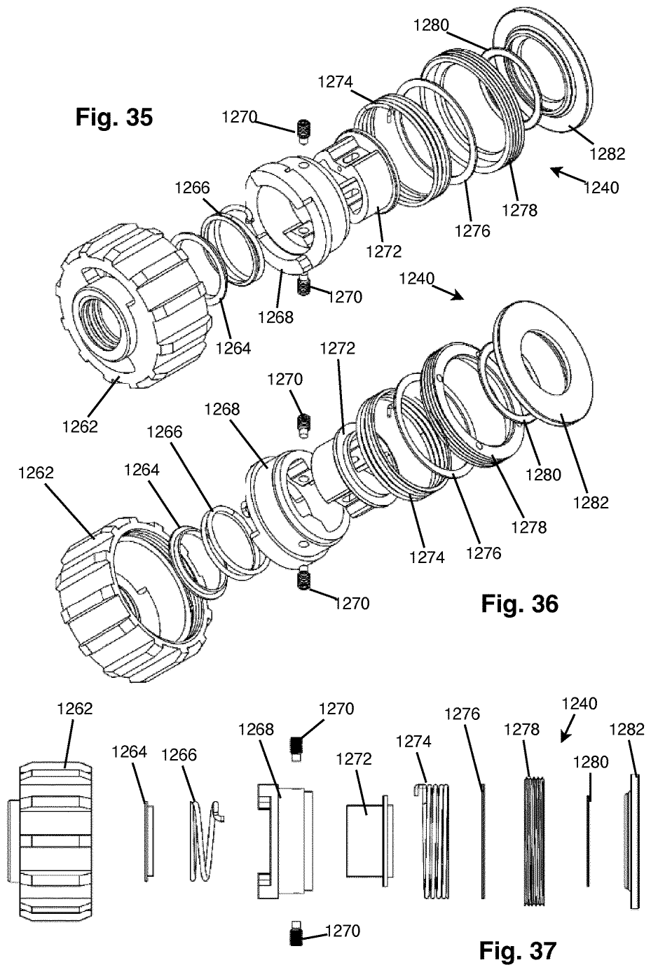

Referring to FIG. 16, FIG. 35, FIG. 36, and FIG. 37, an example of drive shaft assembly 1200 uses an engaging mechanism to lock the transmission nut 1240 relative to a splined drive shaft 1220, aka a drive shaft comprising external threads and surfaces, e.g., inset from the profile of the threads offering a guiding surface. FIG. 16 respectively depict a perspective view of the drive shaft assembly 1200 and a side view of the drive shaft assembly 1200.

The engaging mechanism of the transmission nut 1240 comprises male components adapted to get in the grooves 1222 of the drive shaft 1220 to lock the coupling of the transmission nut 1240 to the drive shaft 1220 to transmit power therethrough when the clutch is engaged by abutting against a surface, e.g. a retractable surface of a output module. A clutch mechanism 1242 is used to pull the male components away from the drive shaft 1220 against the force exerted by the spring 1274 or to release the male components to get them into the grooves 1222.

Referring particularly to FIG. 35 FIG. 36 FIG. 37, the transmission nut 1240 comprises a body 1262 housing a first bushing 1264, a coil spring 1266, an outer dog-clutch 1268 element, an inner dog-clutch element 1272, a coil spring 1274, a second bushing 1276, threaded portion 1278, a third bushing 1280, and a position-transmission dog-clutch element 1282. Mounting nuts 1270 are used for the assembly.

Referring to FIGS. 97 and 98, a clutch 1850 that can be used to operate a drive shaft in accordance with an embodiment comprises a frame element 1852; an output dog clutch support 1854; a dog clutch lock block 1856 comprising prongs 1857 to interface with tether of the dog clutch 1858, an actuator 1866 coupled to a worm screw 1860; a spur gear 1862 comprising inward threads 1864; a screw gear 1870 comprising teeth 1872 extending radially around the axis of the screw gear 1870 and recesses in the teeth 1872 forming a thread 1874; a clutch shaft coupling 1876; and a frame piece 1878. The clutch 1850 further comprises an optical encoder (not depicted) mounted to the spur gear 1862 that is exchanging signals with a controller. number of all possible unique combinations of idle output module(s) with locking present in the assemblies of the demultiplexing section. To determine the number of operating modes 3.X, one must follow the following equation (X=n*(2\hat{ }n)) where (n)=the number of idle output module(s) with locking and (X)=the number of unique combinations or the number of OP3. To create a table of the OP3, a “truth table” of (n) column and (2\hat{ }n) line is created where the 1 is the lock mode and the 0 is the unlock mode of the idle output module(s) with locking. In the OP3, the rotor locking mechanisms attached to the main frame is set to lock mode by the actuator unit where all the rotor of the output module(s) are locked so that the transmission nut can move along the travel path and the actuator unit comprising the electric sliding conductors rail busbars sends a signal to set the transmission nut(s) into clutch or into declutch mode. If the independent clutch mechanism for operating mode 1 is present, it is set to OP2. The rotation of the main motor control the entire drive shaft.

The assemblies of the demultiplexing drive shaft of type splined leadscrew and subtype electrical can be combined with one or a plurality of transmission nut with internal motor.

To change the operating modes, the embedded electronic system controls, via the main motor system, the rotation of the main motor that is connected directly or via another drive shaft to the mechanical input of the central axis of the demultiplexing section drive shaft of type splined leadscrew and subtype electrical and subtype multiple electric sliding conductors rail busbars, and controls, via the actuator unit, the mechanism for the transition of operating modes that comprises, without limitation, one or a plurality of transmission nut(s) of type transmission nut with internal motor and subtype leadscrew that are individually connected to the actuator unit and controlled by the embedded electronic system, connected to the travel path section of the central axis of the demultiplexing section drive shaft.

In this configuration group, the empty spaces for idle transmission nut can be used.

In this configuration group, when a full OP1 needs to be added, an additional independent clutch mechanism for operating mode 1 must be added to the mechanical input of the central axis of the demultiplexing section drive shaft configuration. This additional subsystem makes it possible to switch from the OP2 to the OP1 and from the OP1 to the OP2. To switch between the OP1 and the OP2 and vice versa, the main motor must not be running.

For the operating mode 1, the present independent clutch mechanism for operating mode 1 is set to OP1. The internal motor of transmission nut(s) of type transmission nut with internal motor is set to deactivated mode. The rotation of the main motor has no impact on the drive shaft of this section and on all the following sections.

For the operating mode 2, the internal motor of transmission nut(s) of type transmission nut with internal motor is set to deactivated mode and at least one transmission nut must be inside one output module to be considered to be in OP2. This is considered a partial OP1 if all the transmission nut(s)

1. A demultiplexing drive shaft assembly extending along a drive axis driven by a power source, comprising:
a transmission nut;
a powering element to transmit rotation to the transmission nut around the drive axis;
a leading element to make the transmission nut travel along the drive axis; and
a guiding element to perform linear translation of the transmission nut relative to the drive axis without rotation,
wherein both the powering element and the leading element are both powered by said power source driving the drive axis.

2. The demultiplexing drive shaft assembly of claim 1, the powering element and the leading element are a same, single powering-and-leading structure.

3. The demultiplexing drive shaft assembly of claim 2, further comprising a guiding structure, comprising the guiding element, the guiding structure being different and distinct from the powering-and-leading structure.

4. The demultiplexing drive shaft assembly of claim 2, wherein the powering-and-leading structure is a central leadscrew comprising a spline.

5. The demultiplexing drive shaft assembly of claim 1, the powering element and the guiding element are a same, single powering-and-guiding structure.

6. The demultiplexing drive shaft assembly of claim 5, further comprising a leading structure, comprising the leading element, the leading structure being different and distinct from the powering-and-guiding structure.

7. The demultiplexing drive shaft assembly of claim 6, wherein the leading structure comprises a leadscrew centered on the drive axis, or eccentric relative to the drive axis; and the powering-and-guiding structure is eccentric relative to the drive axis or centered on the drive axis.

8. The demultiplexing drive shaft assembly of claim 1, comprising a powering, leading and guiding structure comprising the powering element, the leading element, and the guiding element.

9. The demultiplexing drive shaft assembly of claim 8, wherein the powering, leading and guiding structure comprises one of:
a central leadscrew comprising a spline;
a gear rack; and
a linear-guide leadscrew being eccentric with respect to the drive axis.

10. The demultiplexing drive shaft assembly of claim 1, comprising at least a second transmission nut,
wherein the transmission nuts are movable along the drive axis.

11. The demultiplexing drive shaft assembly of claim 1, wherein the transmission nut comprises at least one of a container; a motor; an electrical connection; a clutch mechanism; an electronic controller; one or more interface structures contacting the powering element, one or more interface structures contacting the guiding element, and one or more interface structure contacting the leading element.

12. A mechanical demultiplexer comprising:
a frame;
the demultiplexing drive shaft assembly of claim 1 that is coupled to the frame and that is motorized by the power source;
a plurality of output modules coupled to the frame along the demultiplexing drive shaft, with the demultiplexing drive shaft being engageable to the output modules through the transmission nut,
wherein the mechanical demultiplexer is adapted to engage selectively and individually a number of the output modules to the demultiplexing drive shaft resulting in the demultiplexing drive shaft powering the number of engaged output modules.

13. A mechanical demultiplexer, comprising the demultiplexing drive shaft assembly of claim 1 that comprises a demultiplexing section and a non-demultiplexing section, wherein the first transmission nut is adapted to travel only over the demultiplexing section.

14. A mechanical demultiplexer comprising:
a frame;
a drive shaft, motorized by a power source, coupled to the frame and extending along a drive axis defining a longitudinal direction;
a first transmission nut mounted to the drive shaft; and
a plurality of output modules coupled to the frame along the drive shaft, with the drive shaft being engageable to the output modules through the first transmission nut,
wherein the mechanical demultiplexer is adapted to engage selectively and individually a number of the output modules to the drive shaft, resulting in the drive shaft powering the number of engaged output modules.

15. The mechanical demultiplexer of claim 14, wherein the drive shaft comprises:
a powering element to transmit rotation to the first transmission nut around the drive axis;
a leading element to make the first transmission nut travel along the drive axis; and
a guiding element to perform linear translation of the transmission nut relative to the drive axis without rotation;
wherein both the powering element and the leading element are both powered by said power source driving the drive axis.

16. A mechanical demultiplexer of claim 14, wherein the drive shaft comprises a demultiplexing section and a non-demultiplexing section, wherein the first transmission nut is adapted to travel only over the demultiplexing section.

17. The mechanical demultiplexer of claim 14, comprising a second transmission nut, wherein the first transmission nut and the second transmission nut are movable along the drive axis.

18. The mechanical demultiplexer of claim 14, wherein any number from none to all of the plurality of output modules can be engaged simultaneously.

19. The mechanical demultiplexer of claim 14, wherein any number from none to all of the plurality of output modules can be engaged individually.

20. The mechanical demultiplexer of claim 14, wherein the plurality of output modules comprises a second output module, and wherein the first transmission nut is movable and engageable to the first output module and the second output module for the drive shaft to power simultaneously the first output module and the second output module.

21. The mechanical demultiplexer of claim 14, wherein the first transmission nut comprises an outer surface having a non-cylindrical shape interfacing with the output module.

22. The mechanical demultiplexer of claim 14, wherein a first one of the output modules comprises at least a first rotor and at least a first stator.

23. The mechanical demultiplexer of claim 22, wherein the first output module comprises at least one of:
i) a locking mechanism selectively engaging the first stator to the first rotor; and
ii) a friction mechanism engaging the first stator to the first rotor.

24. The mechanical demultiplexer of claim 23, further comprising a linking component linking the locking mechanism of at least two of the plurality of output modules for simultaneous locking thereof.

25. The mechanical demultiplexer of claim 22, wherein a second one of the output modules comprises at least a second rotor and at least a second stator;
wherein the first one of the output modules comprises components each coupled to at least one of the rotor and the stator, the first components being able to perform a first task; and the second one of the output modules comprises components each coupled to at least one of the second rotor and the second stator, the second components being able to perform a second task independent and distinct from the first task.

26. The mechanical demultiplexer of claim 14, wherein the drive shaft comprises two sections coupled to the power source that extend in two distinct directions, or that extend parallel to each other, or that extend from either side of an input of the power source.

27. The mechanical demultiplexer of claim 14, comprising the power source is a single motor motorizing the drive shaft.

28. The mechanical demultiplexer of claim 25, further comprising a linking component linking the first rotor and the second rotor of the first one of the plurality of output modules and second one of the plurality of output modules.

29. A system comprising two mechanical demultiplexers according to claim 14, the system comprising a single controller to control the two mechanical demultiplexers.

30. The system of claim 29, wherein the output modules of at least one of the two mechanical demultiplexers are able to engage the output modules of the other one of the two mechanical demultiplexers.

31. A method of operating a mechanical demultiplexer, comprising:
a) providing a mechanical demultiplexer having a demultiplexing drive shaft assembly and a drive axis,
b) setting the mechanical demultiplexer in a first state in which a transmission nut is drivable to travel along the drive axis;
c) driving the transmission nut along the drive axis between i) a first position in which the transmission nut is distant and disengaged from a first output module, and ii) a second position in which the transmission nut is engaged to the first output module; and
d) setting the mechanical demultiplexer in a second state in which the demultiplexing drive shaft assembly drives the transmission nut to rotate along with the drive shaft without traveling longitudinally along the drive axis, thereby powering the first output module.

32. The method of claim 31, the method further comprising:
e) setting the mechanical demultiplexer in the first state;
f) driving the first transmission nut between i) the second position, and ii) a third position in which the transmission nut is engaged to a second output module; and
g) setting the mechanical demultiplexer in the second state thereby powering solely the second output module.
